(19) United States
(12) Patent Application Publication
(10) Pub. No.: US 2003/0181334 A1
(43) Pub. Date: Sep. 25, 2003

(54) Herbicidal method

(76) Inventors: Clive Cornell, Saffron Walden (GB); Michael Colin Cramp, Braintree (GB); Michael Gingell, Sawbridgeworth (GB); Susan Westaway, Sawbridgeworth (GB)

Correspondence Address: LAW OFFICES, CONNOLLY BOVE LODGE & HUTZ LLP, 1220 MARKET STREET, P.O. BOX 2207, WILMINGTON, DE, 19899, US

(21) Appl. No.: 10/316,457

(22) Filed: Dec. 11, 2002

(30) Foreign Application Priority Data
Dec. 12, 2001 (DE) 10161765.8

(51) Int. Cl. A01N 43/707; A01N 43/66; A01N 43/60; A01N 43/58; A01N 43/54; A01N 43/40

(52) U.S. Cl. 504/229; 504/236; 504/239; 504/230; 504/251; 504/250; 504/235

(57) ABSTRACT

The invention relates to a method for the control of weeds (i.e. undesired vegetation) at a locus, which method comprises applying thereto a herbicidally effective amount of at least one compound which is a 3,5-dicyanophenoxy derivative of formula (I):

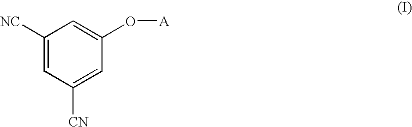

wherein A is as defined in the description; to novel 3,5-dicyanophenoxy derivatives, to new herbicidal compositions containing them, and to processes and intermediates for their preparation.

### BACKGROUND OF THE INVENTION

This invention relates to a new method of controlling weeds, to novel 3,5-dicyanophenoxy derivatives, to new herbicidal compositions containing them, and to processes and intermediates for their preparation.

An object of this invention is to provide a new method of controlling weeds.

A further object of this invention is to provide new compounds which are useful as highly effective herbicides, and to processes for their preparation.

Another object of the instant invention is to provide herbicides which are effective against grasses in addition to broad-leafed weeds.

Another object is to provide herbicides which possess selective herbicidal activity.

Another object is to provide herbicides effective as low dose herbicides.

These and other objects of the instant invention can be achieved in whole or in part by means of the 3,5-dicyanophenoxy derivatives of the invention.

### DESCRIPTION OF THE INVENTION

The present invention provides a method for the control of weeds (i.e. undesired vegetation) at a locus, which method comprises applying thereto a herbicidally effective amount of at least one compound which is a 3,5-dicyanophenoxy derivative of formula (I):

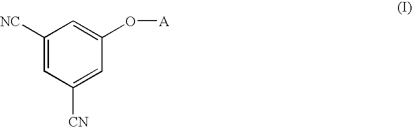

wherein

A is a formula A1 to A5:

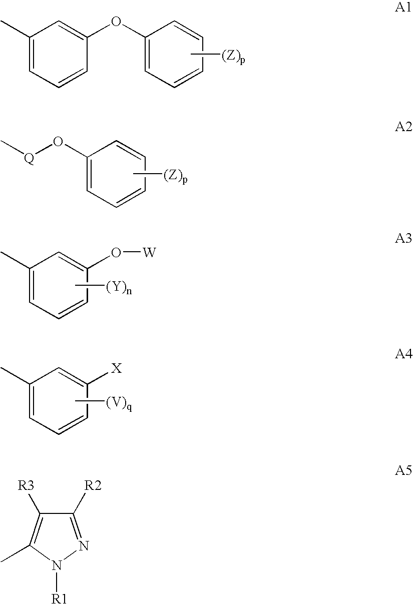

Q is a formula Q1 to Q12:

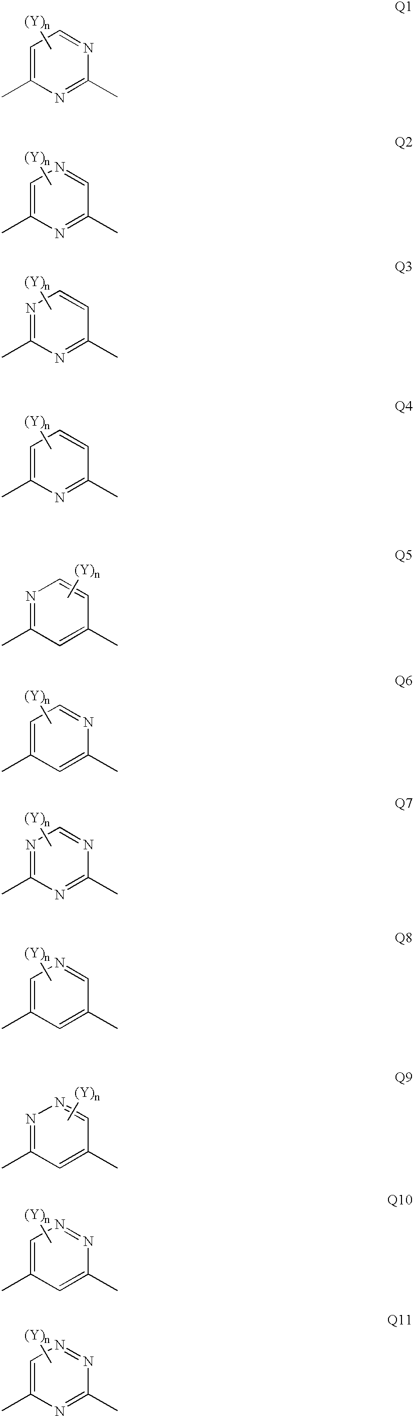

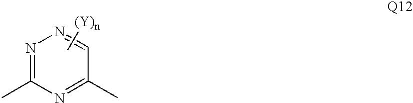

wherein the linking bond shown on the lefthand side of each formula is attached to the 3,5-dicyanophenoxy moiety of formula (I);

W is a formula W1 to W6:

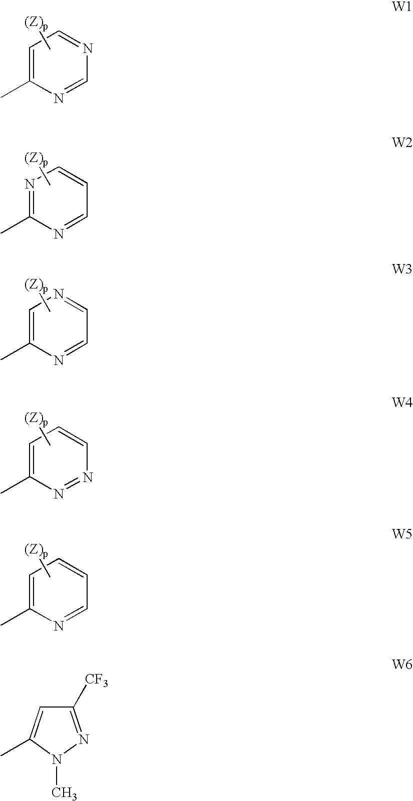

X is halogen, (C₁-C₈)alkyl, (C₁-C₈)haloalkyl, (C₂-C₆)alkenyl, (C₂-C₆)haloalkenyl, (C₂-C₆)alkynyl, (C₂-C₆)haloalkynyl, NO₂, CN, OH, OSO₂R⁴, (C₁-C₆)alkoxy, (C₁-C₆)haloalkoxy, (C₂-C₆)alkenyloxy, (C₂-C₆)haloalkenyloxy, —OC(R⁵R⁶)CO₂R⁴, OC(O)R⁷, —OCH(R⁸)CO₂R⁴, —C(R⁵R⁶)OR⁸ or NR⁵R⁶;

each Y is the same or different halogen;

each Z is independently selected from NO₂, CN, CO₂R², halogen, (C₁-C₈)alkyl, (C₁-C₈)haloalkyl, (C₁-C₆)alkoxy, (C₁-C₆)haloalkoxy, —S(O)ₘ(CH₂)ᵣR⁸, —S(O)ₘR⁴, —CH₂S(O)ₘR⁸, R⁸, NR⁵R⁶, CONR⁵R⁶, CHO and 1-pyrrolyl;

V is Z with the exclusion of CO₂R²;

R¹ is (C₁-C₈)alkyl, (C₁-C₈)haloalkyl or —(CH₂)ₛR⁸;

R² is hydrogen, (C₁-C₅)alkyl or (C₁-C₈)haloalkyl;

R³ is hydrogen, halogen, (C₁-C₈)alkyl or (C₁-C₈)haloalkyl; R⁴ is (C₁-C₈)alkyl or (C₁-C₈)haloalkyl;

R⁵ and R⁶ are each independently hydrogen or (C₁-C₈)alkyl;

R⁷ is (C₁-C₈)alkyl, cycloalkyl, R⁸ or thienyl;

R⁸ is phenyl unsubstituted or substituted by one or more radicals selected from the group consisting of halogen, (C₁-C₈)alkyl, (C₁-C₈)haloalkyl, (C₂-C₆)alkenyl, (C₂-C₆)alkynyl, NO₂, CN, —S(O)ₘR⁴, (C₁-C₆)alkoxy, (C₁-C₆)haloalkoxy and CO₂R⁴;

m is zero, one or two;

n, r and s are each independently zero or one;

p is zero or an integer from one to five;

q is zero or an integer from one to four;

or an agriculturally acceptable salt thereof. These compounds possess valuable herbicidal properties.

The invention is also directed to any stereoisomer, enantiomer, geometric isomer of a compound of the invention as defined above, and to mixtures thereof. It will be understood that the present invention embraces both the pure isomers and more or less enriched mixtures thereof.

By the term “agriculturally acceptable salts” is meant salts the cations or anions of which are known and accepted in the art for the formation of salts for agricultural or horticultural use. Suitable salts with bases include alkali metal (e.g. sodium and potassium), alkaline earth metal (e.g. calcium and magnesium), ammonium and amine (e.g. diethanolamine, triethanolamine, octylamine, morpholine and dioctylmethylamine) salts. Suitable acid addition salts, e.g. formed by compounds of formula I containing an amino group, include salts with inorganic acids, for example hydrochlorides, sulphates, phosphates and nitrates and salts with organic acids for example acetic acid.

In the present patent specification, including the accompanying claims, the aforementioned substituents have the following meanings:

Halogen atom means fluorine, chlorine, bromine or iodine;

The term “halo” before the name of a radical means that this radical is partially or completely halogenated, that is to say, substituted by F, Cl, Br, or I, in any combination.

The expression “(C₁-C₈)alkyl” means an unbranched or branched non-cyclic saturated hydrocarbon radical having 1, 2, 3, 4, 5, 6, 7 or 8 carbon atoms (indicated by a range of C-atoms in the parenthesis), such as, for example a methyl, ethyl, propyl, isopropyl, 1-butyl, 2-butyl, 2-methylpropyl or tert-butyl radical.

“(C₁-C₈)Haloalkyl” means an alkyl group mentioned under the expression “(C₁-C₈)alkyl” in which one or more hydrogen atoms are replaced by the same number of identical or different halogen atoms, such as monohaloalkyl, perhaloalkyl, CF₃, CHF₂, CH₂F, CHFCH₃, CF₃CH₂, CF₃CF₂, CHF₂CF₂, CH₂FCHCl, CH₂Cl, CCl₃, CHCl₂ or CH₂CH₂Cl.

Alkyl and haloalkyl radicals, unless otherwise defined, preferably have 1 to 6 carbon atoms.

“(C₁-C₆)Alkoxy” means an alkoxy group whose carbon chain has the meaning given under the expression “(C₁-C₆)alkyl”. “Haloalkoxy” is, for example, OCF₃, OCHF₂, OCH₂F, CF₃CF₂O, OCH₂CF₃ or OCH₂CH₂Cl.

“(C₂-C₆)Alkenyl” means an unbranched or branched non-cyclic carbon chain having a number of carbon atoms which corresponds to this stated range and which contains at least one double bond which can be located in any position of the respective unsaturated radical. “(C₂-C₆)Alkenyl” accordingly denotes, for example, the vinyl, allyl, 2-methyl-2-propenyl, 2-butenyl, pentenyl, 2-methylpentenyl or the hexenyl group.

“(C₂-C₆)Alkynyl” means an unbranched or branched non-cyclic carbon chain having a number of carbon atoms which corresponds to this stated range and which contains one triple bond which can be located in any position of the respective unsaturated radical. “(C₂-C₆)Alkynyl” accordingly denotes, for example, the propargyl, 1-methyl-2-propynyl, 2-butynyl or 3-butynyl group.

“(C₃-C₆)Cycloalkyl” denotes monocyclic alkyl radicals, such as the cyclopropyl, cyclobutyl, cyclopentyl or cyclohexyl radical. The expression “one or more radicals selected from the group consisting of” in the definition is to be understood as meaning in each case one or more identical or different radicals selected from the stated group of radicals, unless specific limitations are defined expressly.

According to a further feature of the present invention, there is provided a 3,5-dicyanophenoxy derivative of formula (I) as defined above with the provisos:

i) that when A is a formula A1, then Zₚ is not 3,5-dicyano;

ii) that when A is a formula A4 and X is chloro, then V is not 4-chloro;

iii) that when A is a formula A4 and X is methyl, then q is not zero; and

iv) that when A is a formula A4 and X is methyl, then V is not 2-methyl; 2,5-dimethyl or 2,6-dimethyl;

or an agriculturally acceptable salt thereof.

Preferred compounds of formula (I) are those in which A is a formula A5.

A preferred class of compounds of formula (I) are those in which:

A is a formula Al, wherein Z is NO₂, CN, CO₂R² in which R² is (C₁-C₄)alkyl, or is halogen, (C₁-C₄)haloalkyl, (C₁-C₄)haloalkoxy, —SO₂CH₂R⁸ in which R⁸ is phenyl substituted by one or more halogen radicals, or is —CH₂SR⁸ in which R⁸ is phenyl, or is CONH₂, CHO or 1-pyrrolyl; and

p is zero or an integer from one to five.

A further preferred class of compounds of formula (I) are those in which:

A is a formula A2, wherein Q is a formula Q1, Q2 or Q3 in which Z is CN or halogen;

n is zero and p is zero, 1 or 2.

A further preferred class of compounds of formula (I) are those in which:

A is a formula A3, wherein W is a formula W1, W2, W3, W4 or W5; Z is halogen, NH₂, (C₁-C₄)alkyl, (C₁-C₄)haloalkyl, (C₁-C₄)alkoxy, —S(O)ₘR⁴ in which R⁴ is (C₁-C₄)alkyl, or is R⁸ in which R⁸ is phenyl;

n is zero and p is zero, 1, 2 or 3.

A further preferred class of compounds of formula (I) are those in which:

A is a formula A4, wherein X is halogen, (C₁-C₄)alkyl, (C₁-C₄)haloalkyl, (C₂-C₄)haloalkenyl, (C₂-C₄)alkynyl, CN, NO₂, OH, OSO₂R⁴ in which R⁴ is (C₁-C₄)haloalkyl, or is (C₁-C₄)alkoxy, (C₂-C₄)haloalkoxy, (C₂-C₄)haloalkenyloxy, —OC(R⁵R⁶)CO₂R⁴ in which R⁴ is (C₁-C₄)alkyl and R⁵ and R⁶ are each independently hydrogen or (C₁-C₄)alkyl, or is OC(O)R⁷ in which R⁷ is (C₁-C₄)alkyl, (C₃-C₆)cycloalkyl or thienyl, or R⁷ is R⁸ in which R⁸ is phenyl unsubstituted or substituted by one or more radicals selected from the group consisting of halogen, (C₁-C₄)haloalkyl, NO₂, (C₁-C₄)alkoxy and (C₁-C₄)haloalkoxy, or is —OCH(R⁸)CO₂R⁴ in which R⁴ is (C₁-C₄)alkyl and R⁸ is phenyl, or is —C(R⁵R⁶)OR⁸ in which R⁵ and R⁶ are each independently hydrogen or (C₁-C₄)alkyl, and R⁸ is phenyl unsubstituted or substituted by one or two CN groups, or is NR⁵R⁶ in which R⁵ and R⁶ are each independently hydrogen or (C₁-C₄)alkyl;

V is CN, halogen, (C₁-C₄)alkoxy or CONH₂; and q is zero or 1.

A further preferred class of compounds of formula (I) are those in which:

A is a formula A5, wherein R¹ is (C₁-C₄)alkyl, R² is (C₁-C₄)haloalkyl and R³ is H.

Preferred compounds of formula (I) include:

5-[3-(2-chloropyrimidin-4-yloxy)phenoxy]isophthalonitrile (Compound 1)

5-[3-(2-methylthiopyrimidin-4-yloxy)phenoxy]isophthalonitrile (Compound 2)

5-[3-(2,6-dichloropyrimidin-4-yloxy)phenoxy]isophthalonitrile (Compound 3)

5-[3-(6-chloropyrazin-2-yloxy)phenoxy]isophthalonitrile (Compound 4)

5-[3-(4,6-dimethylpyrimidin-2-yloxy)phenoxy]isophthalonitrile (Compound 5)

5-[3-(6-chloro-2-phenylpyrimidin-4-yloxy)phenoxy]isophthalonitrile (Compound 6)

5-[3-(4-trifluoromethylpyrimidin-2-yloxy)phenoxy]isophthalonitrile (Compound 7)

5-[3-(2-amino-6-chloropyrimidin-4-yloxy)phenoxy]isophthalonitrile (Compound 8)

5-[3-(6-chloropyridazin-3-yloxy)phenoxy]isophthalonitrile (Compound 9)

5-[3-(pyrimidin-2-yloxy)phenoxy]isophthalonitrile (Compound 10)

5-[3-(4-amino-3,5-dichloropyridin-2-yloxy)phenoxy]isophthalonitrile (Compound 11)

5-[3-(2,6-dimethoxypyrimidin-4-yloxy)phenoxy]isophthalonitrile (Compound 12)

5-[3-(4,6-dimethoxypyrimidin-2-yloxy)phenoxy]isophthalonitrile (Compound 13)

2-chlorobenzoic acid 3-(3,5-dicyanophenoxy)phenyl ester (Compound 14)

3-chlorobenzoic acid 3-(3,5-dicyanophenoxy)phenyl ester (Compound 15)

4-chlorobenzoic acid 3-(3,5-dicyanophenoxy)phenyl ester (Compound 16)

3,5-bis(trifluoromethyl)benzoic acid 3-(3,5-dicyanophenoxy)phenyl ester (Compound 17)

cyclopropanecarboxylic acid 3-(3,5-dicyanophenoxy)phenyl ester (Compound 18)

thiophene-2-carboxylic acid 3-(3,5-dicyanophenoxy)phenyl ester (Compound 19)

2-chloro-4-nitrobenzoic acid 3-(3,5-dicyanophenoxy)phenyl ester (Compound 20)

2,4-dimethoxybenzoic acid 3-(3,5-dicyanophenoxy)phenyl ester (Compound 21)

2-trifluoromethoxybenzoic acid 3-(3,5-dicyanophenoxy)phenyl ester (Compound 22)

acetic acid 3-(3,5-dicyanophenoxy)phenyl ester (Compound 23)

isobutyric acid 3-(3,5-dicyanophenoxy)phenyl ester (Compound 24)

2,2-dimethylpropionic acid 3-(3,5-dicyanophenoxy)phenyl ester (Compound 25)

5-[3-(3-chlorobut-2-enyloxy)phenoxy]isophthalonitrile (Compound 26)

5-[3-(3-chloro-4,4,4-trifluorobut-2-enyloxy)phenoxy]isophthalonitrile (Compound 27)

[3-(3,5-dicyanophenoxy)phenoxy]acetic acid methyl ester (Compound 28)

2-[3-(3,5-dicyanophenoxy)phenoxy]propionic acid methyl ester (Compound 29)

[3-(3,5-dicyanophenoxy)phenoxy]phenylacetic acid methyl ester (Compound 30)

5-[3-(trifluoromethylsulphonyloxy)phenoxy]isophthalonitrile (Compound 31)

5-(1-methyl-3-trifluoromethylpyrazol-5-yloxy)isophthalonitrile (Compound 32)

5-(3-trifluoromethylphenoxy)isophthalonitrile (Compound 33)

5-(3-t-butylphenoxy)isophthalonitrile (Compound 34)

5-(3-chlorophenoxy)isophthalonitrile (Compound 35)

5-(3-methylphenoxy)isophthalonitrile (Compound 36)

5-(3-fluorophenoxy)isophthalonitrile (Compound 37)

5-(3-nitrophenoxy)isophthalonitrile (Compound 38)

5-(3-iodophenoxy)isophthalonitrile (Compound 39)

5-(3-isopropylphenoxy)isophthalonitrile (Compound 40)

5-(3,4-d ichlorophenoxy)isophthalonitrile (Compound 41)

5-(3-cyanophenoxy)isophthalonitrile (Compound 42)

5-(3,5-difluorophenoxy)isophthalonitrile (Compound 43)

5-(3-[1,1,2,2-tetrafluoroethoxy]phenoxy)isophthalonitrile (Compound 44)

5-(3-aminophenoxy)isophthalonitrile (Compound 45)

5-(3-dimethylaminophenoxy)isophthalonitrile (Compound 46)

5-(3-ethynylphenoxy)isophthalonitrile (Compound 47)

5-(3-bromophenoxy)isophthalonitrile (Compound 48)

5-(3-hydroxyphenoxy)isophthalon itrile (Compound 49)

5-[3-(2-cyano-5-bromophenoxy)-phenoxy]isophthalonitrile (Compound 50)

5-[3-(3,4-dicyanophenoxy)phenoxy]isophthalonitrile (Compound 51)

5-[3-(4-cyano-3-trifluoromethylphenoxy)phenoxy]isophthalonitrile (Compound 52)

5-[3-(2-cyano-5-trifluoromethylphenoxy)phenoxy]isophthalonitrile (Compound 53)

5-[3-(3-chloro-2-cyanophenoxy)phenoxy]isophthalonitrile (Compound 54)

5-{3-[2-cyano-3-(1-pyrrolyl)phenoxy]phenoxy}isophthalonitrile (Compound 55)

5-[3-(3-chloro-4-cyanophenoxy)phenoxy]isophthalonitrile (Compound 56)

5-[3-(2-cyano-3-iodophenoxy)phenoxy]isophthalonitrile (Compound 57)

5-[3-(2-cyano-3-trifluoromethylphenoxy)phenoxy]isophthalonitrile (Compound 58)

5-[3-(2,4-dicyanophenoxy)phenoxy]isophthalon itrile (Compound 59)

2-[3-(3,5-dicyanophenoxy)phenoxy]benzoic acid methyl ester (Compound 60)

5-[3-(3-cyanophenoxy)phenoxy]isophthalonitrile (Compound 61)

5-[3-(4-cyanophenoxy)phenoxy]isophthalonitrile (Compound 62)

5-[3-(5-chloro-2-nitrophenoxy)phenoxy] isophthalonitrile (Compound 63)

4-chloro-2-[3-(3,5-dicyanophenoxy)phenoxy]-3-phenylthiomethylbenzoic acid methyl ester (Compound 64)

5-{3-[4-(4-chlorophenylmethylsulphonyl)phenoxy]phenoxy}isophthalonitrile (Compound 65)

3-[3-(3,5-dicyanophenoxy)phenoxy]-4-nitrobenzamide (Compound 66)

3-[3-(3,5-dicyanophenoxy)phenoxy]-5-cyanobenzamide (Compound 67)

5-[3-(3-cyano-5-trifluoromethylphenoxy)phenoxy]isophthalonitrile (Compound 68)

5-[3-(5-chloro-2-cyanophenoxy)phenoxy]isophthalonitrile (Compound 69)

5-{3-[2-cyano-3-(2,2,2-trifluoroethoxy)phenoxy]phenoxy}isophthalonitrile (Compound 70)

5-[3-(3-cyano-5-fluorophenoxy)phenoxy]isophthalonitrile (Compound 71)

5-[3-(3-cyano-4-trifluoromethylphenoxy)phenoxy]isophthalonitrile (Compound 72)

5-[3-(4-formyl-3-trifluoromethylphenoxy)phenoxy]isophthalonitrile (Compound 73)

5-[3-(2-formyl-3-trifluoromethylphenoxy)phenoxy]isophthalonitrile (Compound 74)

5-[3-(4-cyano-2,3,5,6-tetrafluorophenoxy)phenoxy]isophthalonitrile (Compound 75)

5-[3-phenoxyphenoxy]isophthalonitrile (Compound 76)

5-[3-(3-trifluoromethylphenoxy)phenoxy]isophthalonitrile (Compound 77)

5-[3-(3-fluorophenoxy)phenoxy]isophthalonitrile (Compound 78)

5-[3-(3,4-dichlorophenoxy)phenoxy]isophthalonitrile (Compound 79)

5-[3-(4-chlorophenoxy)phenoxy]isophthalonitrile (Compound 80)

5-[3-(3-chlorophenoxy)phenoxy]isophthalonitrile (Compound 81)

5-{3-[3-(1,1,2,2-tetrafluoroethoxyphenoxy)]phenoxy}isophthalonitrile (Compound 82)

5-[4-(3,5-dichlorophenoxy)pyrimidin-2-yloxy] isophthalonitrile (Compound 83)

5-[2-(3,5-dichlorophenoxy)pyrimidin-4-yloxy]isophthalonitrile (Compound 84)

5-[4-(3,5-dicyanophenoxy)pyrimidin-2-yloxy]isophthalonitrile (Compound 85),

5-[6-(3,5-dicyanophenoxy)pyrazin-2-yloxy]isophthalonitrile (Compound 86), 5-[2-(3-chloro-4-cyanophenoxy)pyrimidin-4-yloxy]isophthalonitrile (Compound 87)

1-(3,5-dicyanophenoxy)-3-(3,5-dicyanophenoxy)methylbenzene (Compound 88)

1-(3,5-dicyanophenoxy)-3-[1-(3,5-dicyanophenoxy)ethyl]benzene (Compound 89) and

5-[3-(3,5-dicyanophenoxy)phenoxy]isophthalonitrile (Compound 90).

Compounds of formula (I) above may be prepared by the application or adaptation of known methods (i.e. methods heretofore used or described in the literature), for example as hereinafter described.

In the following description where symbols appearing in formulae are not specifically defined, it is to be understood that they are “as hereinbefore defined” in accordance with the first definition of each symbol in the specification.

It is to be understood that in the descriptions of the following processes the sequences may be performed in different orders, and that suitable protecting groups may be required to achieve the compounds sought.

According to a feature of the present invention compounds of formula (I) wherein A is a formula A1 and Z and p are as defined above, may be prepared by the reaction of a compound of general formula (II):

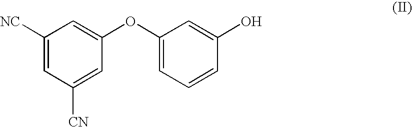

with a compound of formula (III):

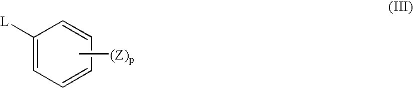

wherein L is a leaving group, generally halogen and preferably fluorine, and Z and p are as defined above. The reaction is generally performed in the presence of a base, for example an alkali metal carbonate such as cesium carbonate or potassium carbonate, and in an inert solvent such as N,N-dimethylformamide or N-methylpyrrolidinone, at a temperature of from 20° C. to the reflux temperature of the solvent.

According to a further feature of the invention compounds of formula (I) wherein A is a formula A3 and W, Y and n are as defined above, may be prepared by the reaction of a compound of general formula (IV):

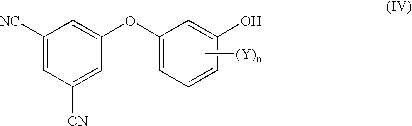

wherein Y and n are as defined in claim 1, with a compound of

formula (V):

L-W (V)

wherein L is a leaving group, generally halogen and preferably fluorine, and W is as defined above. The reaction is generally performed according to the above process for the preparation of compounds of formula (I) wherein A is a formula Al, from a compound of formula (II) and a compound of formula (III).

According to a further feature of the invention compounds of formula (I) wherein A is a formula A2 and Q, Z and p are as defined above, may be prepared by the reaction of a compound of formula (VI):

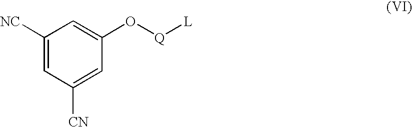

wherein Q is as defined above and L is a leaving group, generally halogen or alkylsulphonyl (preferably methanesulphonyl), with a phenol of formula (VII):

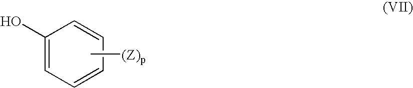

wherein Z and p are as defined above. The reaction is generally performed in the presence of a base, for example an alkali metal carbonate such as cesium carbonate or potassium carbonate, and in an inert solvent such as N,N-dimethylformamide or N-methylpyrrolidinone, at a temperature of from 20 to 100° C.

According to a further feature of the invention compounds of formula (I) wherein A is a formula A4 and X, V and q are as defined above, may be prepared by the reaction of a compound of formula (VIII):

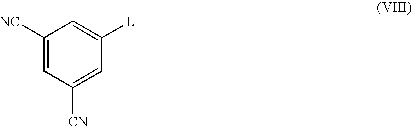

wherein L is a leaving group, generally halogen and preferably fluorine, with a compound of formula (IX):

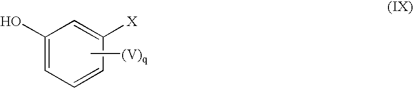

wherein X, V and q are as defined above. The reaction is generally performed according to the above process for the preparation of compounds of formula (I) wherein A is a formula A2, from a compound of formula (VI) and a compound of formula (VII).

According to a further feature of the invention compounds of formula (I) wherein A is a formula A5 and R¹, R² and R³ are as defined above, may be prepared by the reaction of a compound of formula (VIII) as defined above, with a compound of formula (X):

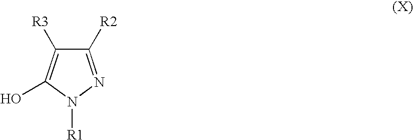

wherein R¹, R² and R³ are as defined above. The reaction is generally performed according to the above process for the preparation of compounds of formula (I) wherein A is a formula A2, from a compound of formula (VI) and a compound of formula (VII).

According to a further feature of the invention compounds of formula (I) wherein A is a formula A1 and Z and p are as defined above, may also be prepared by the reaction of a compound of general formula (XI):

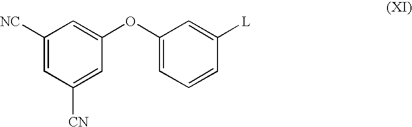

wherein L is a leaving group, generally halogen and preferably bromine or iodine, with a phenol of formula (VII) as defined above. The reaction is performed in the presence of a catalyst preferably a palladium catalyst such as palladium (II) acetate and an alkali metal phosphate such as potassium phosphate, and in an inert solvent such as toluene, at a temperature of from 20° C. to the reflux temperature of the solvent.

According to a further feature of the invention compounds of formula (I) wherein A is a formula A4, V and q are as defined above and X is OC(O)R⁷ wherein R⁷ is as defined above, may be prepared by the reaction of a compound of formula (XII):

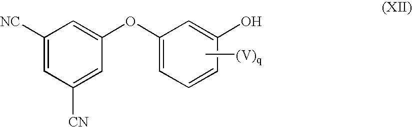

wherein V and q are as defined above, with a compound of formula (XII):

R⁷C(O)Cl (XIII)

wherein R⁷ is as defined above. The reaction is generally performed in the presence of a base, such as a trialkylamine, for example triethylamine, and in an inert solvent such as dichloromethane, at a temperature of from 0° C. to the reflux temperature of the solvent.

According to a further feature of the invention compounds of formula (II) or (XII) as defined above, may be prepared according to the above process for the preparation of compounds of formula (I) wherein A is a formula A4, by the reaction of a compound of formula (VIII) with a compound of formula (IX) wherein X is OH, and q is zero, or V and q are as defined above.

According to a further feature of the invention compounds of formula (IV) wherein Y and n are as defined above, may be prepared by the reaction of a compound of formula (VIII) as defined above, with a compound of formula (XIV):

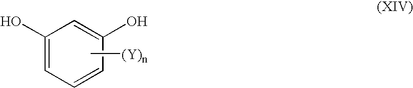

wherein Y and n are as defined above. The reaction is generally performed in the presence of a base, for example an alkali metal carbonate such as cesium carbonate or potassium carbonate, and in an inert solvent such as N,N-dimethylformamide or N-methylpyrrolidinone, at a temperature of from 20° C. to the reflux temperature of the solvent.

According to a further feature of the invention compounds of formula (XI) as defined above wherein L is halogen, may be prepared according to the above process for the preparation of compounds of formula (I) by the reaction of a compound of formula (VIII) as defined above, with a compound of formula (IX) wherein X is halogen and q is zero.

Intermediates of formula (VI) may be prepared by the reaction of a compound of formula (XV):

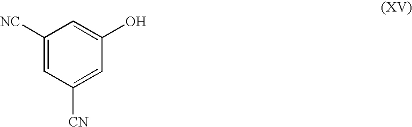

with a compound of formula (XVI):

L-Q-L¹ (XVI)

wherein Q is defined above and L and L¹ are each a leaving group generally halogen, preferably fluorine or chlorine, or alkylsulphonyl. The leaving groups L and L¹ may be selected such that the group L¹ forms the more reactive leaving group.

The intermediate of formula (II) may be prepared by the reaction of a compound of formula (VII) with resorcinol. The reaction is generally performed according to the above process for the preparation of compounds of formula (IV) by the reaction of a compound of formula (VII) with a compound of formula (XIV).

Intermediates of formula (X) may be prepared by the reaction of a compound of formula (XVII):

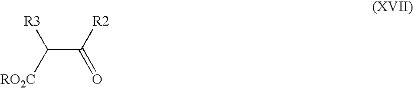

wherein R² and R³ are as defined above and R is (C₁-C₆)alkyl preferably methyl or ethyl, with a compound of formula (XVIII):

R¹NHNH₂ (XVIII)

wherein R¹ is as defined above. The reaction is generally performed in a solvent such as an alcohol, for example ethanol, at a temperature of from 20° C. to the reflux temperature of the solvent. Intermediates of formula (VI) are novel and as such form a further feature of the invention.

Intermediates of formula (III), (V), (VII), (VIII), (IX), (X), (XIII), (XIV), (XVI), (XVII) and (XVIII) are known or may be prepared by known methods.

A collection of compounds of formula (I) which can be synthesized by the abovementioned processes can additionally be prepared in parallel fashion, which can be effected manually, partly automated or fully automated. In this context, it is possible to automate the procedure of the reaction, work-up or purification of the products or intermediates. In total, this is to be understood as meaning a procedure which is described, for example, by S. H. DeWitt in “Annual Reports in Combinatorial Chemistry and Molecular Diversity: Automated Synthesis”, Volume 1, published by Escom, 1997, pages 69 to 77.

For carrying out the reaction and work-up in parallel fashion, a series of commercially available apparatuses can be used as they are available from, for example, Stem Corporation, Woodrolfe Road, Tollesbury, Essex, CM98SE, England or H+P Labortechnik GmbH, Bruckmannring 28, 85764 Oberschleissheim, Germany. To carry out the parallel purification of compounds (I) or of intermediates obtained during the preparation, there are available, inter alia, chromatographic equipment, for example from ISCO, Inc., 4700 Superior Street, Lincoln, Nebr. 68504, USA. The equipment mentioned makes possible a modular procedure, where the individual steps are automated, but manual operation has to be carried out between the steps. This can be circumvented by employing partly or fully integrated automation systems, in which the automation modules in question are operated by, for example, robots. Such automation systems can be obtained from, for example, Zymark Corporation, Zymark Center, Hopkinton, Mass. 01748, USA.

In addition to the above-described methods, compounds of formula (I) can be prepared in full or partly by solid-phase supported methods. To this end, individual intermediates or all intermediates of the synthesis or of a synthesis adapted to the procedure in question are bound to a synthesis resin. Solid-phase supported synthetic methods are described extensively in the specialist literature, for example: Barry A. Bunin in “The Combinatorial Index”, published by Academic Press, 1998. The use of solid-phase supported synthesis methods permits a series of protocols known from the literature which, in turn, can be carried out manually or in an automated fashion. For example, the “teabag method” (Houghten, U.S. Pat. No. 4,631,211; Houghten et al., Proc. Natl. Acad. Sci., 1985, 82, 5131-5135) can be partly automated with products of IRORI, 11149 North Torrey Pines Road, La Jolla, Calif. 92037, USA. Solid-phase supported parallel synthesis can be automated successfully for example using equipment by Argonaut Technologies, Inc., 887 Industrial Road, San Carlos, Calif. 94070, USA or MultiSynTech GmbH, Wullener Feld 4, 58454 Witten, Germany.

The preparation in accordance with the processes described herein yields compounds of formula (I) in the form of substance collections or substance libraries. Subject matter of the present invention are therefore also libraries of the compounds of formula (I) which contain at least two compounds of formula (I), and of their precursors.

The following non-limiting examples illustrate the preparation of the compounds of formula (I).

### A. CHEMICAL EXAMPLES

NMR spectra were run in deuterochloroform unless stated otherwise.

### Example 1

Anhydrous potassium carbonate (30 mg) was added to a solution of 5-(3-hydroxyphenoxy)isophthalonitrile (47 mg) in N,N-dimethylformamide and the mixture stirred under an atmosphere of nitrogen for 15 minutes. 2,4-Dichloropyrimidine (30 mg) was added and the mixture stirred for 1 hour, then ethyl acetate was added and the mixture filtered. The filtrate was washed with aqueous hydrochloric acid (2M), dried (anhydrous magnesium sulphate), concentrated and purified by dry column chromatography on silica (eluent ethyl acetate/isohexane 3:7) to give 5-[3-(2-chloropyrimidin-4-yloxy)phenoxy]isophthalonitrile (Compound 1, 21 mg), NMR 8.42 (1H, d); 7.57 (1H, t); 7.52-7.40 (3H, m); 7.06 (1H, dd); 6.94 (1H, dd); 6.90-6.81 (2H, m).

The following compounds were prepared in a similar manner:

5-[3-(2-methylthiopyrimidin-4-yloxy)phenoxy]isophthalonitrile (Compound 2), NMR 8.31 (1H, d); 7.56 (1H, t); 7.50-7.40 (3H, m); 7.05 (1H, dd); 6.92 (1H, dd); 6.86 (1H, t); 6.54 (1H, d); 2.32 (3H, s);

5-[3-(2,6-dichloropyrimidin-4-yloxy)phenoxy]isophthalonitrile (Compound 3), NMR 7.66 (1H, t); 7.56 (1H, t); 7.52 (2H, d); 7.12 (1H, dd); 7.04 (1H, dd); 6.94 (1H, s); 6.91 (1H, t);

5-[3-(6-chloropyrazin-2-yloxy)phenoxy]isophthalonitrile (Compound 4), NMR 8.36 (1H, s); 8.34 (1H, s); 7.68 (1H, t); 7.57-7.51 (3H, m); 7.14 (1H, dd); 7.00 (1H, dd); 6.95 (1H, t);

5-[3-(4,6-dimethylpyrimidin-2-yloxy)phenoxy]isophthalonitrile (Compound 5), NMR 7.54 (1H, t); 7.42 (2H, d); 7.41 (1H, t); 7.10 (1H, dd); 6.90-6.83 (2H, m); 6.74 (1H, s); 2.37 (6H, s);

5-[3-(6-chloro-2-phenylpyrimidin-4-yloxy)phenoxy]isophthalonitrile (Compound 6), NMR 8.17 (2H, dt); 7.56 (1H, t); 7.49 (1H, t); 7.42 (2H, d); 7.43-7.31 (3H, m); 7.12 (1H, dd); 6.95-6.90 (2H, m); 6.78 (1H, s);

5-[3-(4-trifluoromethylpyrimidin-2-yloxy)phenoxy]isophthalonitrile (Compound 7), NMR 8.84 (1H, d); 7.65 (1H, t); 7.58-7.50 (3H, m); 7.44 (1H, d); 7.20 (1H, dd); 7.04-6.98 (2H, m);

5-[3-(2-amino-6-chloropyrimidin-4-yloxy)phenoxy]isophthalonitrile (Compound 8), NMR 7.65 (1H, t); 7.52 (1H, t); 7.50 (2H, d); 7.09 (1H, dd); 6.99 (1H, dd); 6.88 (1H, t);

6.29 (1H, s); 5.16 (2H, bs);

5-[3-(6-chloropyridazin-3-yloxy)phenoxy]isophthalonitrile (Compound 9), NMR 7.64 (1H, t); 7.60-7.45 (4H, m); 7.25 (1H, d); 7.19 (1H, dd); 7.01 (1H, t); 6.96 (1H, dd);

5-[3-(pyrimidin-2-yloxy)phenoxy]isophthalonitrile (Compound 10), NMR 8.61 (2H, d); 7.62 (1H, t); 7.58-7.49 (3H, m); 7.17 (1H, dd); 7.12 (1H, t); 7.02-6.94 (2H, m);

5-[3-(4-amino-3,5-dichloropyridin-2-yloxy)phenoxy]isophthalon itrile (Compound 11), NMR 8.04 (1H, s); 7.61 (1H, t); 7.45 (2H, d); 7.30 (1H, t); 6.80 (1H, dd); 6.62-6.56 (2H, m); 5.20 (2H, bs);

5-[3-(2,6-dimethoxypyrimidin-4-yloxy)phenoxy]isophthalonitrile (Compound 12), NMR 7.65 (1H, t); 7.52-7.44 (3H, m); 7.11 (1H, dd); 6.95 (1H, dd); 6.90 (1H, t); 5.86 (1H, s); 4.97 (3H, s); 4.91 (3H, s); and 5-[3-(4,6-dimethoxypyrimidin-2-yloxy)phenoxy]isophthalonitrile (Compound 13), NMR 7.61 (1H, t); 7.52-7.42 (3H, m); 7.18 (1H, dd); 7.00-6.90 (2H, m); 5.80 (1H, s); 3.86 (6H, s).

### Example 2

2-Chlorobenzoyl chloride (17.5 mg) was added to a solution of 5-(3-hydroxyphenoxy)isophthalonitrile (23.6 mg) in dichloromethane and the mixture stirred for 15 minutes. Triethylamine (11.1 mg) was added and stirring continued for 18 hours. Dichloromethane was added and the mixture washed with aqueous hydrochloric acid (2M), aqueous sodium hydroxide (2M) and water. The organic solution was dried (anhydrous magnesium sulphate) and concentrated to give 2-chlorobenzoic acid 3-(3,5-dicyanophenoxy)phenyl ester (Compound 14, 25.4 mg), NMR 7.97 (1H, dd); 7.56 (1H, t); 7.49-7.44 (3H, m); 7.41 (2H, d); 7.35-7.33 (1H, m); 7.14 (1H, dd); 6.96 (1H, t); 6.92 (1H, dd).

The following compounds were prepared in a similar manner:

3-chlorobenzoic acid 3-(3,5-dicyanophenoxy)phenyl ester (Compound 15), NMR 8.10 (1H, t); 8.00 (1H, dt); 7.58-7.54 (2H, m); 7.45 (1H, t); 7.42 (2H, d); 7.40 (1H, t); 7.13-7.08 (1H, m); 6.93 (1H, dd); 6.91 (1H, d);

4-chlorobenzoic acid 3-(3,5-dicyanophenoxy)phenyl ester (Compound 16), NMR 8.06 (2H, d); 7.56 (1H, t); 7.46-7.43 (3H, m); 7.42 (2H, d); 7.12-7.07 (1H, m); 6.93-6.91 (1H, m); 6.91 (1H, d);

3,5-bis(trifluoromethyl)benzoic acid 3-(3,5-dicyanophenoxy)phenyl ester (Compound 17), NMR 8.57 (2H, s); 8.09 (1H, s); 7.58 (1H, t); 7.50 (1H, t); 7.43 (2H, d); 7.14 (1H, ddd); 6.97 (1H, ddd); 6.93 (1H, d);

cyclopropanecarboxylic acid 3-(3,5-dicyanophenoxy)phenyl ester (Compound 18), NMR 7.55 (1H, t); 7.38 (2H, d); 7.38 (1H, t); 6.99 (1H, ddd); 6.85 (1H, ddd); 6.80 (1H, t); 1.82-1.71 (1H, m); 1.14-0.90 (4H, m);

thiophene-2-carboxylic acid 3-(3,5-dicyanophenoxy)phenyl ester (Compound 19), NMR 7.9 (1H, dd); 7.62 (1H, dd); 7.56 (1H, t); 7.43 (1H, t); 7.41 (2H, d); 7.13-7.09 (2H, m); 6.94-6.87 (2H, m);

2-chloro-4-nitrobenzoic acid 3-(3,5-dicyanophenoxy)phenyl ester (Compound 20), NMR 8.33 (1H, d); 8.18 (1H, dd); 8.13 (1H, t); 7.58 (1H, t); 7.48 (1H, t); 7.42 (2H, d); 7.16 (1H, ddd); 6.99-6.93 (2H, m);

2,4-dimethoxybenzoic acid 3-(3,5-dicyanophenoxy)phenyl ester (Compound 21), NMR 7.99 (1H, d); 7.54 (1H, t); 7.41 (1H, t); 7.40 (2H, d); 7.09 (1H, ddd); 6.91 (1H, t); 6.87 (1H, ddd); 6.50 (1H, dd); 6.46 (1H, d); 3.85 (3H, s); 3.82 (3H, s);

2-trifluoromethoxybenzoic acid 3-(3,5-dicyanophenoxy)phenyl ester (Compound 22), NMR 8.05 (1H, dd); 7.63-7.58 (1H, m); 7.56 (1H, t); 7.45 (1H, t); 7.42 (2H, d); 7.40-7.32 (2H, m); 7.12 (1H, ddd); 6.96 (1H, d); 6.91 (1H, ddd);

acetic acid 3-(3,5-dicyanophenoxy)phenyl ester (Compound 23), NMR 7.56 (1H, t); 7.39 (2H, d); 7.38 (1H, t); 6.98 (1H, ddd); 6.86 (1H, ddd); 6.79 (1H, t); 2.23 (3H, s);

isobutyric acid 3-(3,5-dicyanophenoxy)phenyl ester (Compound 24), NMR 7.55 (1H, t); 7.39 (1H, t); 7.38 (2H, d); 6.97 (1H, ddd); 6.85 (1H, ddd); 6.79 (1H, t); 2.73 (1H, septet); 1.24 (6H, d); and

2,2-dimethylpropionic acid 3-(3,5-dicyanophenoxy)phenyl ester (Compound 25), NMR 7.55 (1H, t); 7.39 (1H, t); 7.38 (2H, d); 6.95 (1H, ddd); 6.85 (1H, ddd); 6.77 (1H, t); 1.28 (9H,s).

### Example 3

5-(3-Hydroxyphenoxy)isophthalonitrile (47.2 mg), anhydrous potassium carbonate (30.4 mg) and acetone were combined and stirred under a nitrogen atmosphere for 0.5 hour. A solution of 1,3-dichloro-2-butene (27.3 mg) in acetone was added and the mixture stirred at 60° C. for 18 hours. The cooled mixture was diluted with water, extracted (ethyl acetate), washed (water), dried (anhydrous magnesium sulphate), concentrated and purified by dry column chromatography on silica (eluent ethyl acetate/isohexane) to give 5-[3-(3-chlorobut-2-enyloxy)phenoxy]isophthalonitrile (Compound 26, 36 mg), NMR 7.53 (1H, t); 7.36 (2H, d); 7.27 (1H, t); 6.75 (1H, dd); 6.57 (1H, dd); 6.52 (1H, t); 5.86 (t) & 5.68 (t) (1H); 4.61 (d) & 4.45 (d) (2H).

By proceeding in a similar manner the following compounds were also prepared:

5-[3-(3-chloro-4,4,4-trifluorobut-2-enyloxy)phenoxy]isophthalonitrile (Compound 27), NMR 7.54 (1H, t); 7.37 (2H, d); 7.32 (1H, t); 6.75 (1H, dd); 6.68 (1H, t); 6.62 (1H, dd); 6.53 (1H, t); 4.78 (2H, d);

[3-(3,5-dicyanophenoxy)phenoxy]acetic acid methyl ester (Compound 28), NMR 7.54 (1H, t); 7.36 (2H, d); 7.29 (1H, t); 6.74 (1H, dd); 6.62 (1H, dd); 6.56 (1H, t); 4.58 (2H, s); 3.74 (3H, s);

2-[3-(3,5-dicyanophenoxy)phenoxy]propionic acid methyl ester (Compound 29), NMR 7.53 (1H, t); 7.35 (2H, d); 7.27 (1H, t); 6.70 (1H, dd); 6.59 (1H, dd); 6.52 (1H, t); 4.72 (1H, q); 3.70 (3H, s); 1.58 (3H, d); and

[3-(3,5-dicyanophenoxy)phenoxy]phenylacetic acid methyl ester (Compound 30), NMR 7.52 (1H, t); 7.50-7.44 (2H, m); 7.36-7.17 (6H, m); 6.78 (1H, dd); 6.62-6.55 (2H, m); 5.55 (1H, s); 3.65 (3H, s).

### Example 4

Anhydrous potassium carbonate (76 mg) was added to a solution of 5-(3-hydroxyphenoxy)isophthalonitrile (118 mg) in N,N-dimethylformamide and stirred under an atmosphere of nitrogen for 15 minutes. A solution of 1-methyl-3-trifluoromethyl-5-trifluoromethylsulphonyloxypyrazole (150 mg) in dimethylformamide was added and the mixture was stirred for 1 hour. The reaction mixture was diluted with water, extracted (ethyl acetate), washed with aqueous hydrochloric acid (2M) and saturated brine, dried (anhydrous magnesium sulphate), and concentrated to give 5-[3-(trifluoromethylsulphonyloxy)phenoxy]isophthalonitrile (Compound 31, 126 mg), NMR 7.72 (1H, t); 7.58 (1H, t); 7.50 (2H, d); 7.25 (1H, dd); 7.12 (1H, dd); 7.06 (1H, t).

### Example 5

5-Fluoroisophthalonitrile (37 mg), 3-hydroxy-1-methyl-3-trifluoromethylpyrazole (58 mg), anhydrous potassium carbonate (55 mg) and N,N-dimethylformamide were combined and stirred under a nitrogen atmosphere at 100° C. for 3 hours then left to stand overnight at room temperature. The mixture was diluted (ethyl acetate), washed with water, aqueous sodium hydroxide (2M) and brine, dried (anhydrous magnesium sulphate) and concentrated to give 5-(1-methyl-3-trifluoromethylpyrazol-5-yloxy)isophthalonitrile (Compound 32, 34 mg), NMR 7.84 (1H, t); 7.67 (2H, d); 6.09 (1H, s); 3.86 (3H, s).

By proceeding in a similar manner the following compounds were also prepared:

5-(3-trifluoromethylphenoxy)isophthalonitrile (Compound 33), NMR 7.59 (1H, t); 7.53 (1H, t); 7.51-7.46 (1H, m); 7.37 (2H, d); 7.25 (1H, bs); 7.20-7.15 (1H, m);

5-(3-t-butylphenoxy)isophthalonitrile (Compound 34), NMR 7.60 (1H, t); 7.43 (2H, d); 7.40 (1H, t); 7.35 (1H, dt); 7.11 (1H, t); 6.86 (1H, ddd); 1.38 (9H, s);

5-(3-chlorophenoxy)isophthalonitrile (Compound 35), NMR 7.65 (1H, t); 7.45 (2H, d); 7.41 (1H, t); 7.32-7.27 (1H, m); 7.09 (1H, t); 6.98 (1H, ddd);

5-(3-methylphenoxy)isophthalonitrile (Compound 36), NMR 7.59 (1H, t); 7.42 (2H, d); 7.35 (1H, t); 7.12 (1H, d); 6.88 (1H, s); 6.89-6.83 (1H, m); 2.41 (3H, s);

5-(3-fluorophenoxy)isophthalonitrile (Compound 37), NMR 7.66 (1H, t); 7.47 (2H, d); 7.48-7.40 (1H, m); 7.07-6.99 (1H, m); 6.87 (1H, dd); 6.81 (1H, dt);

5-(3-nitrophenoxy)isophthalonitrile (Compound 38), NMR 8.09 (1H, ddd); 7.84 (1H, t); 7.65 (1H, t); 7.60 (1H, t); 7.44 (2H, d); 7.35 (1H, ddd);

5-(3-iodophenoxy)isophthalonitrile (Compound 39), NMR 7.58-7.54 (2H, m); 7.36-7.34 (3H, m); 7.11 (1H, t); 6.96 (1H, ddd);

5-(3-isopropylphenoxy)isophthalonitrile (Compound 40), NMR 7.50 (1H, t); 7.33 (2H, d); 7.29 (1H, t); 7.12-7.06 (1H, m); 6.85 (1H, t); 6.77 (1H, ddd); 2.95-2.70 (1H, m); 1.18 (6H, d);

5-(3,4-dichlorophenoxy)isophthalonitrile (Compound 41), NMR 7.59 (1H, t); 7.45 (1H, d); 7.38 (2H, d); 7.12 (1H, d); 6.86 (1H, dd);

5-(3-cyanophenoxy)isophthalonitrile (Compound 42), NMR 7.72 (1H, t); 7.63-7.59 (2H, m); 7.48 (2H, d); 7.37 (1H, m); 7.33 (1H, m);

5-(3,5-difluorophenoxy)isophthalonitrile (Compound 43), NMR 7.72 (1H, t); 7.51 (2H, d); 6.78 (1H, tt); 6.62 (2H, dd);

5-(3-[1,1,2,2-tetrafluoroethoxy]phenoxy)isophthalonitrile (Compound 44), NMR 7.68 (1H, t); 7.50 (1H, t); 7.47 (2H, d); 7.20 (1H, dd); 7.02-6.96 (2H, m); 5.95 (1H, tt);

5-(3-aminophenoxy)isophthalonitrile (Compound 45), NMR 7.59 (1H, t); 7.44 (2H, d); 7.23 (1H, t); 6.61 (1H, ddd); 6.42 (1H, ddd); 6.37 (1H, t); 3.86 (2H, bs);

5-(3-dimethylaminophenoxy)isophthalonitrile (Compound 46), NMR 7.57 (1H, t); 7.43 (2H, d); 7.29 (1H, t); 6.64 (1H, dd); 6.36 (1H, d); 6.35 (1H, dd); 2.99 (6H, s);

5-(3-ethynylphenoxy)isophthalonitrile (Compound 47), NMR 7.64 (1H, t); 7.46-7.42 (4H, m); 7.20-7.18 (1H, m); 7.11-7.04 (1H, m); 3.18 (1H, s);

5-(3-bromophenoxy)isophthalonitrile (Compound 48), NMR 7.67 (1H, t); 7.45 (3H, m); 7.36 (1H, t); 7.25 (1H, t); 7.00 (1H, dd); and

5-(3-hydroxyphenoxy)isophthalonitrile (Compound 49), m.p. 143° C.

By proceeding in a similar manner but using cesium carbonate instead of potassium carbonate, there were prepared the following compounds:

5-[3-(2-cyano-5-bromophenoxy)-phenoxy]isophthalonitrile (Compound 50), NMR 7.68 (1H, t); 7.58-7.49 (4H, m); 7.38 (1H, dd); 7.16 (1H, d); 7.01 (1H, dd); 6.96 (1H, dd); 6.85 (1H, t);

5-[3-(3,4-dicyanophenoxy)phenoxy]isophthalonitrile (Compound 51), NMR 7.77 (1H, d); 7.67 (1H, d); 7.54 (1H, t); 7.50 (2H, d); 7.38 (1H, d); 7.35 (1H, dd); 6.99 (2H, m); 6.79 (1H, t);

5-[3-(4-cyano-3-trifluoromethylphenoxy)phenoxy]isophthalonitrile (Compound 52), NMR 7.83 (1H, d); 7.68 (1H, d); 7.55 (1H, t); 7.50 (2H, d); 7.42 (1H, d); 7.25 (1H, dd); 7.02 (1H, dd); 6.98 (1H, dd); 6.84 (1H, t);

5-[3-(2-cyano-5-trifluoromethylphenoxy)phenoxy]isophthalonitrile (Compound 53), NMR 7.85 (1H, d); 7.68 (1H, t); 7.58-7.47 (4H, m); 7.24 (1H, s); 7.02 (1H, dd); 6.98 (1H, dd); 6.87 (1H, t);

5-[3-(3-chloro-2-cyanophenoxy)phenoxy]isophthalonitrile (Compound 54), NMR 7.67 (1H, t); 7.54-7.45 (4H, m); 7.29 (1H, dd); 7.01 (1H, ddd); 6.94 (1H, dd); 6.91 (1H, dd); 6.85 (1H, t);

5-{3-[2-cyano-3-(1-pyrrolyl)phenoxy]phenoxy}isophthalon itrile (Compound 55), NMR 7.56 (1H, s); 7.50 (1H, t); 7.42 (1H, t); 7.41 (2H, d); 7.13-7.03 (3H, m); 6.96 (1H, dd); 6.87-6.78 (3H, m); 6.33 (2H, t);

5-[3-(3-chloro-4-cyanophenoxy)phenoxy]isophthalonitrile (Compound 56), NMR 7.69-7.64 (2H, m); 7.52 (1H, t); 7.49 (2H, d); 7.14 (1H, d); 7.02 (1H, d); 6.99 (1H, d); 6.95 (1H, dd); 6.82 (1H, t);

5-[3-(2-cyano-3-iodophenoxy)phenoxy]isophthalonitrile (Compound 57), NMR 7.69 (1H, dd); 7.67 (1H, t); 7.53-7.46 (3H, m); 7.26 (1H, t); 7.02-6.96 (2H, m); 6.92 (1H, dd); 6.83 (1H, t); and

5-[3-(2-cyano-3-trifluoromethylphenoxy)phenoxy]isophthalonitrile (Compound 58), NMR 7.72-7.65 (2H, m); 7.58-7.48 (4H, m); 7.22 (1H, d); 7.03 (1H, dd); 6.96 (1H, dd); 6.87 (1H, t).

### Example 6

A mixture of 5-(3-hydroxyphenoxy)isophthalonitrile (94 mg) and anhydrous potassium carbonate (55 mg) in 1-methyl-2-pyrrolidinone was stirred at 100° C. under a nitrogen atmosphere for 30 minutes then allowed to cool slightly. 4-Bromoisophthalonitrile (124 mg) was added and the mixture heated at 100° C. for 1.5 hours. The cooled mixture was partitioned between ethyl acetate and water, the aqueous phase was extracted with ethyl acetate and the combined organic solution washed with aqueous sodium hydroxide (2M) and water. The ethyl acetate solution was dried (anhydrous magnesium sulphate) and concentrated and purified by dry column chromatography on silica (eluent dichloromethane/isohexane 2:1) to give 5-[3-(2,4-dicyanophenoxy)phenoxy]isophthalonitrile (Compound 59, 73 mg), NMR (D₆ DMSO) 8.57 (1H, d); 8.26 (1H, t); 8.09 (1H, dd); 8.03 (2H, d); 7.60 (1H, t); 7.24-7.10 (3H, m).

### Example 7

A mixture of 5-(3-hydroxyphenoxy)isophthalonitrile (50 mg), anhydrous potassium carbonate (35 mg) and methyl 2-fluorobenzoate (49 mg) in dry N,N-dimethylformamide was heated and stirred at 140° C. for 2.5 hours under a nitrogen atmosphere. The mixture was purified by dry column chromatography on silica, eluting with ethyl acetate/isohexane, to give 2-[3-(3,5-dicyanophenoxy)phenoxy]benzoic acid methyl ester (Compound 60, 6 mg), NMR 7.89 (1H, dd); 7.52 (1H, t); 7.48 (1H, td); 7.36 (2H, d); 7.30 (1H, t); 7.20 (1H, td); 7.04 (1H, dd); 6.77 (1H, dd); 6.66 (1H, dd); 6.55 (1H, t); 3.75 (3H, s).

By proceeding in a similar manner the following compounds were also prepared:

5-[3-(3-cyanophenoxy)phenoxy]isophthalonitrile (Compound 61), NMR 7.60 (1H, t); 7.59-7.53 (2H, m); 7.40 (1H, t); 7.39 (2H, d); 7.04 (1H, t); 7.01 (1H, t); 6.90 (1H, dd); 6.82 (1H, dd); 6.71 (1H, t);

5-[3-(4-cyanophenoxy)phenoxy]isophthalonitrile (Compound 62), NMR 7.60 (1H, t); 7.59-7.53 (2H, m); 7.40 (1H, t); 7.39 (2H, d); 7.03 (1H, t); 7.02 (1H, t); 6.90 (1H, ddd); 6.82 (1H, ddd); 6.72 (1H, t);

5-[3-(5-chloro-2-nitrophenoxy)phenoxy]isophthalonitrile (Compound 63), NMR 7.91 (1H, d); 7.57 (1H, t); 7.49 (1H, dd); 7.38 (2H, d); 7.37 (1H, t); 7.05 (1H, d); 6.83 (1H, ddd); 6.78 (1H, ddd); 6.67 (1H, t);

4-chloro-2-[3-(3,5-dicyanophenoxy)phenoxy]-3-phenylthiomethylbenzoic acid methyl ester (Compound 64), NMR 7.81 (1H, d); 7.60 (1H, t); 7.42 (2H, d); 7.40-7.21 (7H, m); 6.71 (2H, dt); 6.43 (1H, t); 4.24 (2H, s); 3.71 (3H, s); 5-{3-[4-(4-chlorophenylmethylsulphonyl)phenoxy]phenoxy}isophthalonitrile (Compound 65), NMR 7.77-7.61 (3H, m); 7.49 (1H, t); 7.48 (2H, d); 7.30-7.25 (2H, m); 7.09 (2H, d); 6.97 (1H, dd); 6.90 (1H, dd); 6.79 (1H, t); 4.30 (2H, s);

3-[3-(3,5-dicyanophenoxy)phenoxy]-4-nitrobenzamide (Compound 66), NMR 8.35 (1H, d); 7.98 (1H, dd); 7.57 (1H, t); 7.42 (1H, t); 7.41 (2H, d); 7.10 (1H, d); 6.92 (1H, ddd); 6.85 (1H, ddd); 6.72 (1H, t); 5.85(2H, bs);

3-[3-(3,5-dicyanophenoxy)phenoxy]-5-cyanobenzamide (Compound 67), NMR 7.73 (1H, bs); 7.66 (1H, t); 7.58 (1H, t); 7.44-7.37 (4H, m); 6.87 (1H, dd); 6.83 (1H, dd); 6.69 (1H, t); 5.98 (2H, bs);

5-[3-(3-cyano-5-trifluoromethyl phenoxy)phenoxy]isophthalonitrile (Compound 68), NMR 7.70-7.66 (2H, m); 7.56-7.44 (5H, m); 6.98 (1H, dd); 6.95 (1H, dd); 6.81 (1H, t);

5-[3-(5-chloro-2-cyanophenoxy)phenoxy]isophthalonitrile (Compound 69), NMR 7.59 (1H, t); 7.55 (1H, d); 7.44 (1H, t); 7.42 (2H, d); 7.13 (1H, dd); 6.93 (1H, dd); 6.91 (1H, d); 6.87 (1H, dd); 6.77 (1H, t);

5-{3-[2-cyano-3-(2,2,2-trifluoroethoxy)phenoxy]phenoxy}isophthalonitrile (Compound 70), NMR 7.66 (1H, t); 7.51 (1H, t); 7.49 (1H, t); 7.48 (2H, d); 7.02 (1H, dd); 6.92 (1H, dd); 6.84 (1H, dd); 6.75 (1H, d); 6.68 (1H, d); 4.55 (2H, q);

5-[3-(3-cyano-5-fluorophenoxy)phenoxy]isophthalonitrile (Compound 71), NMR 7.58 (1H, t); 7.42 (1H, t); 7.41 (2H, d); 7.08-7.01 (2H, m); 6.93 (1H, dt); 6.89 (1H, dd); 6.84 (1H, dd); 6.71 (1H, t);

5-[3-(3-cyano-4-trifluoromethylphenoxy)phenoxy]isophthalonitrile (Compound 72), NMR 7.70 (1H, d); 7.59 (1H, t); 7.45 (1H, t); 7.42 (2H, d); 7.36 (1H, d); 7.25 (1H, dd); 6.92 (1H, dd); 6.88 (1H, dd); 6.74 (1H, t);

5-[3-(4-formyl-3-trifluoromethylphenoxy)phenoxy]isophthalonitrile (Compound 73), NMR 10.20 (1H, s); 8.08 (1H, d); 7.58 (1H, t); 7.44 (1H, t); 7.41 (2H, d); 7.32 (1H, d); 7.18 (1H, dd); 6.94 (1H, dd); 6.87 (1H, dd); 6.76 (1H, t);

5-[3-(2-formyl-3-trifluoromethylphenoxy)phenoxy]isophthalonitrile (Compound 74), NMR 10.45 (1H, s); 7.58 (1H, t); 7.57 (1H, t); 7.55 (1H, t); 7.40 (2H, d); 7.39 (1H, t); 7.17 (1H, d); 6.85 (1H, dd); 6.79 (1H, dd); 6.71 (1H, t); and

5-[3-(4-cyano-2,3,5,6-tetrafluorophenoxy)phenoxy]isophthalonitrile (Compound 75), NMR 7.59 (1H, t); 7.39 (2H, d); 7.38 (1H, t); 6.86-6.80 (2H, m); 6.73 (1H, t).

### Example 8

A mixture of 3-phenoxyphenol (93 mg) and anhydrous potassium carbonate (69 mg) in 1-methyl-2-pyrrolidinone was stirred at 100° C. under a nitrogen atmosphere for 30 minutes then allowed to cool slightly. 4-Fluoroisophthalonitrile (73 mg) was added and the mixture heated at 100° C. for 1 hour. The cooled mixture was added to water, extracted (ethyl acetate), washed with aqueous sodium hydroxide (2M) and water, then dried (anhydrous magnesium sulphate) and concentrated to give a yellow semi-solid. Trituration with isohexane gave 5-[3-phenoxyphenoxy]isophthalonitrile (Compound 76, 50 mg), NMR (D₆ DMSO) 7.62 (1H, t); 7.45 (2H, d); 7.44-7.37 (3H, m); 7.19 (1H, t); 7.12-7.06 (2H, m); 6.92 (1H, ddd); 6.77 (1H, ddd); 6.71 (1H, t).

### Example 9

A mixture of 5-(3-bromophenoxy)isophthalonitrile (75 mg), 3-hydroxybenzotrifluoride (61 mg), palladium(II) acetate (11 mg), tripotassium phosphate (0.106 g) and 2-(di-tert-butylphosphino)biphenyl (18 mg) in dry toluene was heated at reflux under a nitrogen atmosphere for 24 hours. Water and ethyl acetate were added to the cooled mixture, followed by acidification with aqueous hydrochloric acid (2M). The phases were separated and the organic layer dried over magnesium sulphate, concentrated and purified by flash chromatography. Elution with 5% ethyl acetate/i-hexane gave 5-[3-(3-trifluoromethylphenoxy)phenoxy]isophthalonitrile (Compound 77, 32 mg), NMR 7.62 (1H, s); 7.52-7.37 (5H, m); 7.31 (1H, s); 7.25 (1H, d); 6.92 (1H, dd); 6.82 (1H, dd); 6.73 (1H, t).

By proceeding in a similar manner the following compounds were also prepared:

5-[3-(3-fluorophenoxy)phenoxy]isophthalonitrile (Compound 78), NMR 7.63 (1H, t); 7.47 (2H, d); 7.43 (1H, t); 7.35 (1H, dt); 6.95 (1H, dd); 6.93-6.73 (5H, m);

5-[3-(3,4-dichlorophenoxy)phenoxy]isophthalonitrile (Compound 79), NMR 7.55 (1H, t); 7.41-7.32 (4H, m); 7.10 (1H, d); 6.88-6.82 (2H, m); 6.75 (1H, dd); 6.64 (1H, t);

5-[3-(4-chlorophenoxy)phenoxy]isophthalonitrile (Compound 80), NMR 7.54 (1H, t); 7.38-7.23 (5H, m); 6.97-6.91 (2H, m); 6.82 (1H, dd); 6.70 (1H, dd); 6.61 (1H, t);

5-[3-(3-chlorophenoxy)phenoxy]isophthalonitrile (Compound 81), NMR 7.63 (1H, t); 7.46 (2H, d); 7.43 (1H, t); 7.32 (1H, t); 7.16 (1H, dd); 7.08 (1H, t); 7.00-6.90 (2H, m); 6.82 (1H, dd); 6.73 (1H, t); and

5-{3-[3-(1,1,2,2-tetrafluoroethoxyphenoxy)]phenoxy}isophthalonitrile (Compound 82), NMR 7.63 (1H, t); 7.46 (2H, d); 7.44 (1H, t); 7.40 (1H, t); 7.05 (1H, dd); 7.02-6.92 (3H, m); 6.83 (1H, dd); 6.74 (1H, t); 5.93 (1H, tt).

### Example 10

5-(4-Methanesulphonylpyrimidin-2-yloxy)isophthalonitrile (31.2 mg), 3,5-dichlorophenol (16.8 mg), anhydrous potassium carbonate (16.5 mg) and N,N-dimethylformamide were combined and stirred under a nitrogen atmosphere for 3 hours. The mixture was diluted (ethyl acetate) and washed with aqueous sodium hydroxide (2M), water and brine, then dried (anhydrous magnesium sulphate), concentrated and purified by dry column chromatography on silica (eluent dichloromethane) to give 5-[4-(3,5-d ichlorophenoxy)pyrimidin-2-yloxy]isophthalonitrile (Compound 83, 16 mg), m.p. 156° C.

### Example 11

2-Chloro-4-(3,5-dicyanophenoxy)pyrimidine (0.385 g), 3,5-dichlorophenol (0.27 g), anhydrous potassium carbonate (0.275 g) and N,N-dimethylformamide were combined and stirred under a nitrogen atmosphere at 100° C. for 3 hours. The reaction mixture was partitioned between diethyl ether and water, and the organic phase washed with aqueous sodium hydroxide (1M) and water, then dried (anhydrous magnesium sulphate), concentrated and purified by dry column chromatography on silica (eluent dichloromethane/ethyl acetate 4:1) to give 5-[2-(3,5-dichlorophenoxy)pyrimidin-4-yloxy]isophthalonitrile (Compound 84, 0.15 g), m.p. 196° C.

### Example 12

Anhydrous potassium carbonate (76 mg) was added to a solution of 5-hydroxyisophthalonitrile (72 mg) in N,N-dimethylformamide and the mixture stirred under an atmosphere of nitrogen for 30 minutes. 2,4-Dichloropyrimidine (37 mg) was added and the mixture stirred for 2 hours at 70° C., cooled, diluted with water and extracted (ethyl acetate). The extract was washed with water, dried (anhydrous magnesium sulphate) and evaporated to give 5-[4-(3,5-dicyanophenoxy)pyrimidin-2-yloxy]isophthalonitrile (Compound 85, 53 mg), NMR 8.39 (1H, d); 7.81 (1H, t); 7.76 (1H, t); 7.68 (2H, d); 7.66 (2H, d); 6.84 (1H, d).

By proceeding in a similar manner the following compound was also prepared:

5-[6-(3,5-dicyanophenoxy)pyrazin-2-yloxy]isophthalonitrile (Compound 86), NM R 8.28 (2H, s); 7.75 (2H, t); 7.55 (4H, d).

### Example 13

A mixture of anhydrous potassium carbonate (0.30 g), 2,4-bis(3-chloro-4-cyanophenoxy)pyrimidine (0.29 g) and 5-hydroxyisophthalonitrile (0.25 g) in N,N-dimethylformamide was stirred at room temperature under an atmosphere of nitrogen for 7 hours. The mixture was partitioned between diethyl ether and water, and the ethereal solution washed with aqueous sodium hydroxide (1M) and water, dried (anhydrous magnesium sulphate), concentrated and purified by dry column chromatography on silica (eluent dichloromethane) to give 5-[2-(3-chloro-4-cyanophenoxy)pyrimidin-4-yloxy]isophthalonitrile (Compound 87, 25 mg), NMR 8.40 (1H, d); 7.80 (1H, s); 7.71 (2H, s); 7.65 (1H, d); 7.30 (1H, d); 7.10 (1H, dd); 6.80 (1H, d).

### Example 14

To a solution of 3-hydroxybenzyl alcohol (0.125 g) in 1-methyl-2-pyrrolidinone under a nitrogen atmosphere was added sodium hydride (60% in oil, 92 mg) and xylene, and the mixture heated so that the xylene was distilled off. After cooling slightly, 5-fluoroisophthalonitrile (0.274 g) was added and the mixture heated at 180° C. for 1 hour. The mixture was cooled to 20° C., diluted (ethyl acetate), washed (water) and the aqueous solution extracted (ethyl acetate). The combined extracts were dried over magnesium sulphate, evaporated and purified by dry column chromatography on silica (eluent dichloromethane) to give 1-(3,5-dicyanophenoxy)-3-(3,5-dicyanophenoxy)methylbenzene (Compound 88, 0.186 g), NMR 7.65 (1H, t); 7.57 (1H, t); 7.55 (1H, t); 7.46 (2H, d); 7.44 (2H, d); 7.36 (1H, bd); 7.15 (1H, t); 7.09 (1H, dd); 5.19 (2H, s).

### Example 15

To a solution of 1-(3-hydroxyphenyl)ethanol (69 mg) in 1-methyl-2-pyrrolidinone under a nitrogen atmosphere was added sodium hydride (60% in oil, 44 mg). The mixture was stirred at 20° C. for 10 minutes then 5-fluoroisophthalonitrile (0.161 g) was added and the mixture heated at 100° C. for 0.5 hour then at 150° C. for a further 0.5 hour. The cooled mixture was diluted (ethyl acetate), washed (water), dried over magnesium sulphate, evaporated and purified by dry column chromatography on silica (eluent dichloromethane/isohexane) to yield 1-(3,5-dicyanophenoxy)-3-[1-(3,5-dicyanophenoxy)ethyl]benzene (Compound 89, 84 mg), NMR (300 MHz, CDCl₃) 7.56 (1H, t); 7.45-7.38 (2H, m); 7.32 (2H, d); 7.24 (2H, d); 7.22-7.18 (1H, m); 6.98 (1H, t); 6.92 (1H, dd); 5.29 (1H, quartet); 1.66 (3H, d).

### Example 16

To a solution of resorcinol (6.6 mmol) in N-methylpyrrolidin-2-one (8 ml) was added potassium carbonate (1.63 g) and xylene, and the mixture heated under a nitrogen atmosphere so that the xylene was distilled off. After cooling slightly, 5-fluoroisophthalonitrile (13.6 mmol) was added and the mixture heated at 190° C. for 1.25 hours. The cooled mixture was poured into ice/water, extracted with ethyl acetate, washed (water), dried (magnesium sulphate), concentrated and purified by flash chromatography. Elution with a dichloromethane/i-hexane gave 5-[3-(3,5-dicyanophenoxy)phenoxy]isophthalonitrile (Compound 90, 1.49 g), m.p. 212-213° C.

The following Reference Examples illustrate the preparation of intermediates used in the synthesis of the compounds of formula (I).

### Reference Example 1

Pyridine (3.21 ml) and 4-dimethylaminopyridine (10 mg) were added to a solution of 3-hydroxy-1-methyl-3-trifluoromethylpyrazole (3.0 g) in dichloromethane with stirring at −15° C. under an atmosphere of nitrogen. After 5 minutes trifluoromethanesulphonic anhydride (2.7 ml) was added over 3 minutes at −10° C. to −15° C. The dark solution was stirred at −10° C. for 1.5 hour and then at 20° C. for 2 hours. The mixture was poured into ice, extracted (dichloromethane), dried (anhydrous magnesium sulphate), and concentrated to give a cloudy liquid that was purified by dry column chromatography on silica (eluent ethyl acetate/isohexane) to give 1-methyl-3-trifluoromethyl-5-trifluoromethylsulphonyloxypyrazole (3.91 g), NMR 6.46 (1H, s); 3.93 (3H, s).

### Reference Example 2

To a solution of dry N,N-dimethylformamide (12.3 g) in dry acetonitrile at −5° C. under a nitrogen atmosphere was added oxalyl chloride (19.7 g) over 10 minutes. After stirring for 15 minutes, 5-fluoroisophthalamide (12.4 g) was added in one portion and the mixture was stirred at 0° C. for 1.5 hour. Pyridine (24.6 g) was added dropwise over 5 minutes, and the mixture stirred at 0° C. for 2 hours then poured into aqueous hydrochloric acid (1M) and extracted (ether). The ether extract was washed (water), dried (magnesium sulphate) and concentrated to give 5-fluoroisophthalonitrile (9.13 g), NMR 7.80 (1H, t); 7.67 (2H, dd).

### Reference Example 3

Thionyl chloride (23.3 g) was added dropwise over 1 minute to a suspension of 5-fluoroiso-phthalic acid (14.4 g) in dry toluene and dry N,N-dimethylformamide (1.75 ml). The mixture was stirred at reflux for 3 hours then cooled to 0° C. and added portionwise over 15 minutes to ice-cold ammonia solution. The resulting suspension was stirred at 0° C. for 10 minutes then warmed to 20° C. over 1 hour. The solid was filtered, washed (water) and dried to give 5-fluoroisophthalamide (13.24 g), NMR 8.25 (1H, t); 8.11 (2H, bs); 7.81 (2H, dd); 7.64 (2H, bs).

### Reference Example 4

A solution of 5-fluoro-m-xylene (15.0 g) in t-butanol and water was heated to 70° C. under nitrogen and potassium permanganate (105 g) added in portions over 5 hours. The mixture was heated to reflux after each addition then cooled to 70° C. before the next addition. The mixture was then heated at reflux for 2 hours, cooled to 40° C. and filtered (HyFlo). The pad was washed with aqueous sodium hydroxide (0.5M) and the combined filtrate and washings were acidified (hydrochloric acid) and extracted (ethyl acetate). The extract was washed (water), dried (magnesium sulphate) and concentrated to give 5-fluoroisophthalic acid (15.3 g), NMR 8.37 (1H, t); 7.97 (2H, dd).

### Reference Example 5

m-Chloroperoxybenzoic acid (70%, 1.05 g) was added to a stirred suspension of 5-(4-methylthiopyrimidin-2-yloxy)isophthalonitrile (0.58 g) in dichloromethane at 0° C., then left to stand overnight at room temperature. The mixture was cooled to 0° C., filtered and washed with dichloromethane and ether to give 5-(4-methanesulphonylpyrimidin-2-yloxy)isophthalonitrile (0.373 g), m.p. 189°-191° C.

### Reference Example 6

Anhydrous potassium carbonate (0.50 g) was added to a solution of 5-hydroxyisophthalonitrile (0.46 g) in N,N-dimethylformamide and the mixture stirred under an atmosphere of nitrogen for 0.5 hour. 2-Chloro-4-methylthiopyrimidine (0.50 g) was added and the stirred mixture heated at 70° C. for 3 hours, then at 100° C. for 3 hours, and left at room temperature overnight. Ethyl acetate and water were added and the solid filtered and washed with ethyl acetate and water, then dried under vacuum to give 5-(4-methylthiopyrimidin-2-yloxy)isophthalonitrile (0.65 g), m.p. 237° C.

### Reference Example 7

Using the method of Example 3 starting from 2,4-dichloropyrimidine there was prepared 2-chloro-4-(3,5-dicyanophenoxy)pyrimidine, NMR 8.57 (1H, d); 7.87 (1H, t); 7.75 (2H, d); 7.01 (1H, d).

### Reference Example 8

Using the method of Example 12 starting from 2,4-dichloropyrimidine there was prepared 2,4-bis(3-chloro-4-cyanophenoxy)pyrimidine, NMR 8.40 (1H, d); 7.70 (1H, d); 7.65 (1H, d); 7.31 (1H, d); 7.29 (1H, d); 7.15 (2H, m); 7.81 (1H, m).

According to the herbicidal method of the invention, the said compound of formula (I) is normally used in the form of a herbicidal composition (i.e. in association with compatible diluents or carriers and/or surface active agents suitable for use in herbicidal compositions), for example as hereinafter described.

The compounds of formula (I) and their salts, all termed hereinbelow as compounds of formula (I), have an excellent herbicidal activity against a broad range of economically important monocotyledonous and dicotyledonous harmful plants. The compounds of formula (I) also act efficiently on perennial weeds which produce shoots from rhizomes, root stocks or other perennial organs and which are difficult to control. In this context, it does not matter whether the substances are applied pre-planting, pre-emergence or post-emergence.

Specifically, examples may be mentioned of some representatives of the monocotyledonous and dicotyledonous weed flora which can be controlled by the compounds of formula (I), without the enumeration being a restriction to certain species.

Examples of weed species on which the compounds of formula (I) act efficiently are, from amongst the monocotyledons, Avena, Lolium, Alopecurus, Phalaris, Echinochloa, Digitaria, Setaria and also Cyperus species from the annual sector and from amongst the perennial species Agropyron, Cynodon, Imperata and Sorghum, and also perennial Cyperus species.

In the case of the dicotyledonous weed species, the range of action extends to species such as, for example, Galium, Viola, Veronica, Lamium, Stellaria, Amaranthus, Sinapis, Ipomoea, Matricaria, Abutilon and Sida from amongst the annuals, and Convolvulus, Cirsium, Rumex and Artemisia in the case of the perennial weeds.

The compounds of formula (I) likewise effect outstanding control of weeds which occur under the specific conditions of rice growing, such as, for example, Sagittaria, Alisma, Eleocharis, Scirpus and Cyperus.

If the compounds of formula (I) are applied to the soil surface before germination, then the weed seedlings are either prevented completely from emerging, or the weeds grow until they have reached the cotyledon stage but then their growth stops, and, eventually, after three to four weeks have elapsed, they die completely.

If the compounds of formula (I) are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crop plants, is eliminated at a very early point in time and in a sustained manner.

Even though the compounds of formula (I) have an excellent herbicidal activity against monocotyledonous and dicotyledonous weeds, crop plants of economically important crops, such as, for example, wheat, barley, rye, rice, maize, sugar beet, cotton and soya, are damaged not at all, or only to a negligible extent. For these reasons, the present compounds are highly suitable for selectively controlling undesired plant growth in plantings for agricultural use, inclusive of ornamental plantings.

In addition, the compounds of formula (I) have excellent growth-regulating properties in crop plants. They engage in the plant metabolism in a regulating manner and can thus be employed for the targeted control of plant constituents and for facilitating harvesting, such as, for example, by provoking desiccation and stunted growth. Furthermore, they are also suitable for generally regulating and inhibiting undesired vegetative growth, without simultaneously destroying the plants. Inhibition of vegetative growth plays an important role in many monocotyledonous and dicotyledonous crops because lodging can be reduced hereby, or prevented completely.

The invention therefore also relates to the use of the compounds of formula (I) as herbicides or plant growth regulators.

Due to their herbicidal and plant-growth regulatory properties, the compounds of formula (I) can also be employed for controlling harmful plants in crops of known genetically modified plants, or genetically modified plants yet to be developed. As a rule, the transgenic plants are distinguished by particular advantageous properties, for example by resistances to certain pesticides, mainly certain herbicides, resistances to plant diseases or pathogens of plant diseases, such as certain insects or microorganisms such as fungi, bacteria or viruses. Other particular properties relate, for example, to the harvested material with regard to quantity, quality, storage properties, composition and specific constituents. Thus, transgenic plants are known where the starch content is increased or the starch quality is altered or those where the harvested material has a different fatty acid spectrum.

The compounds of formula (I) are preferably employed in economically important transgenic crops of useful plants and ornamentals, for example cereals such as wheat, barley, rye, oats, sorghum and millet, rice, cassaya and maize, or else crops of sugar beet, cotton, soya, oil seed rape, potatoes, tomatoes, peas and other vegetables.

The compounds of formula (I) can preferably be employed as herbicides in crops of useful plants which are resistant to the phytotoxic effects of the herbicides or have been rendered thus by means of genetic engineering.

Traditional ways of generating novel plants which have modified characteristics in comparison with existing plants consist, for example, in traditional breeding methods and the generation of mutants. However, it is also possible to generate novel plants with altered characteristics with the aid of genetic engineering methods (see, for example, EP-A-0221044, EP-A-0131624). For example, several cases have been described of

genetic engineering modifications of crop plants with the purpose of modifying the starch synthesized in the plants (for example WO 92/11376, WO 92/14827, WO 91/19806),

transgenic crop plants which are resistant to certain herbicides of the glufosinate type (cf., for example, EP-A-0242236, EP-A-242246) or the glyphosate type (WO 92/00377) or the sulfonylurea type (EP-A-0257993, U.S. Pat. No. 5,013,659),

transgenic crop plants, for example cotton, which are capable of producing Bacillus thuringiensis toxins (Bt toxins) which make the plants resistant to specific pests (EP-A-0142924, EP-A-0193259),

transgenic crop plants whose fatty acid spectrum is modified (WO 91/13972).

A large number of techniques in molecular biology by means of which novel transgenic plants with altered characteristics can be generated are known in principle; see, for example, Sambrook et al., 1989, Molecular Cloning, A Laboratory Manual, 2nd Ed., Cold Spring Harbor Laboratory Press, Cold Spring Harbor, N.Y.; or Winnacker “Gene und Klone” [Genes and Clones], VCH Weinheim 2nd Edition 1996, or Christou, “Trends in Plant Science” 1 (1996) 423-431).

In order to perform such genetic engineering manipulations, nucleic acid molecules may be introduced into plasmids which allow mutagenesis or a sequence change by means of recombination of DNA sequences. It is possible, for example, with the aid of the abovementioned standard methods to perform base exchanges, to remove subsequences or to add natural or synthetic sequences. To connect the DNA fragments to each other, adaptors or linkers may be attached to the fragments.

For example, plant cells with a reduced activity of a gene product can be generated by expressing at least one corresponding antisense RNA, a sense RNA to achieve a cosuppressory effect or by expressing at least one ribozyme of suitable construction which specifically cleaves transcripts of the abovementioned gene product.

To this end it is possible to make use of, on the one hand, DNA molecules which encompass the entire coding sequence of a gene product inclusive of any flanking sequences which may be present, on the other hand DNA molecules which only encompass parts of the coding sequence, but these parts must be long enough in order to effect, in the cells, an antisense effect. Use may also be made of DNA sequences which show a high degree of homology to the coding sequences of a gene product, but which are not completely identical.

When nucleic acid molecules are expressed in plants, the protein which has been synthesized may be located in any desired compartment of the plant cell. However, to achieve localization in a particular compartment, it is possible, for example, to link the coding region with DNA sequences which guarantee localization in a particular compartment. Such sequences are known to the skilled worker (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells may be regenerated by known techniques to give complete plants. In principle, the transgenic plants can be plants of any desired plant species, that is to say monocotyledonous and also dicotyledonous plants.

This allows transgenic plants to be obtained which exhibit altered characteristics by means of overexpression, suppression or inhibition of homologous (=natural) genes or gene sequences or by means of expression of heterologous (=foreign) genes or gene sequences.

The compounds of formula (I) can preferably be employed in transgenic crops which are resistant to herbicides from the group of the sulfonylureas, glufosinate-ammonium or glyphosate-isopropylammonium and analogous active substances.

When the compounds of formula (I) according to the invention are used in transgenic crops, effects other than the herbicidal effects to be observed in other crops are frequently found which are specific for application in the particular transgenic crop, for example an altered or specifically widened weed spectrum which can be controlled, altered application rates which may be employed for application, preferably good combining ability with the herbicides to which the transgenic crop is resistant, and an effect on growth and yield of the transgenic crop plants.

The invention therefore also relates to the use of compounds of formula (I) as herbicides for controlling harmful plants in transgenic crop plants.

The use according to the invention for controlling harmful plants or for regulating the growth of plants also includes the case where the compounds of formula (I) are only formed in the plant or the soil from a precursor (“prodrug”) after its application to the plant.

The compounds of formula (I) can be employed in the conventional preparations as wettable powders, emulsifiable concentrates, sprayable solutions, dusts or granules. The invention therefore also relates to herbicidal and plant-growth-regulating compositions which comprise compounds of formula (I).

According to a further feature of the present invention, there is provided a herbicidal composition comprising an effective amount of a compound of formula (I) as defined above or an agriculturally acceptable salt thereof, in association with, and preferably homogeneously dispersed in, one or more compatible agriculturally-acceptable diluents or carriers and/or surface active agents [i.e. diluents or carriers and/or surface active agents of the type generally accepted in the art as being suitable for use in herbicidal compositions and which are compatible with compounds of the invention]. The term “homogeneously dispersed” is used to include compositions in which the compounds of formula (I) are dissolved in other components. The term “herbicidal compositions” is used in a broad sense to include not only compositions which are ready for use as herbicides but also concentrates which must be diluted before use.

The compounds of formula (I) can be formulated in various ways, depending on the prevailing biological and/or chemico-physical parameters. Examples of possible formulations which are suitable are: wettable powders (WP), water-soluble powders (SP), water-soluble concentrates, emulsifiable concentrates (EC), emulsions (EW) such as oil-in-water and water-in-oil emulsions, sprayable solutions, suspension concentrates (SC), dispersions on an oil or water basis, solutions which are miscible with oil, capsule suspensions (CS), dusts (DP), seed-dressing products, granules for broadcasting and soil application, granules (GR) in the form of microgranules, spray granules, coated granules and adsorption granules, water-dispersible granules (WG), water-soluble granules (SG), ULV formulations, microcapsules and waxes.

These individual formulation types are known in principle and described, for example, in: Winnacker-Küchler, “Chemische Technologie” [Chemical Technology], Volume 7, C. Hauser Verlag, Munich, 4th Edition 1986; Wade van Valkenburg, “Pesticide Formulations”, Marcel Dekker, N.Y., 1973; K. Martens, “Spray Drying Handbook”, 3rd Ed. 1979, G. Goodwin Ltd. London.

The necessary formulation auxiliaries such as inert materials, surfactants, solvents and other additives are also known and described, for example, in: Watkins, “Handbook of Insecticide Dust Diluents and Carriers”, 2nd Ed., Darland Books, Caldwell N.J.; H.v. Olphen, “Introduction to Clay Colloid Chemistry”, 2nd Ed., J. Wiley & Sons, N.Y.; C. Marsden, “Solvents Guide”, 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflächenaktive Äthylenoxidaddukte” [Surface-active ethylene oxide adducts], Wiss. Verlagsgesell., Stuttgart 1976; Winnacker-Küchler, “Chemische Technologie” [Chemical Technology], Volume 7, C. Hauser Verlag, Munich, 4th Ed. 1986.

Based on these formulations, it is also possible to prepare combinations with other pesticidally active substances such as, for example, insecticides, acaricides, herbicides, fungicides, and with safeners, fertilizers and/or growth regulators, for example in the form of a readymix or a tank mix.

Wettable powders are preparations which are uniformly dispersible in water and which, besides the compounds of formula (I), also comprise ionic and/or nonionic surfactants (wetters, dispersants), for example, polyoxyethylated alkylphenols, polyoxyethylated fatty alcohols, polyoxyethylated fatty amines, fatty alcohol polyglycol ether sulfates, alkanesulfonates or alkylbenzenesulfonates, sodium lignosulfonate, sodium 2,2′-dinaphthylmethane-6,6′-disulfonate, sodium dibutylnaphthalenesulfonate or else sodium oleoylmethyltaurinate, in addition to a diluent or inert substance. To prepare the wettable powders, the herbicidal compounds of formula (I) are, for example, ground finely in conventional apparatuses such as hammer mills, blower mills and air-jet mills and mixed with the formulation auxiliaries, either concomitantly or thereafter. Emulsifiable concentrates are prepared, for example, by dissolving the compounds of formula (I) in an organic solvent, for example butanol, cyclohexanone, dimethylformamide, xylene or else higher-boiling aromatics or hydrocarbons or mixtures of these, with addition of one or more ionic and/or nonionic surfactants (emulsifiers). Emulsifiers which can be used are, for example: calcium salts of alkylarylsulfonic acids, such as calcium dodecylbenzenesulfonate or nonionic emulsifiers, such as fatty acid polyglycol esters, alkylaryl polyglycol ethers, fatty alcohol polyglycol ethers, propylene oxide/ethylene oxide condensates, alkyl polyethers, sorbitan esters such as sorbitan fatty acid esters or polyoxyethylene sorbitan esters such as polyoxyethylene sorbitan fatty acid esters.

Dusts are obtained by grinding the active substance with finely divided solid substances, for example talc or natural clays, such as kaolin, bentonite or pyrophyllite, or diatomaceous earth.

Suspension concentrates may be water- or oil-based. They can be prepared, for example, by wet grinding by means of commercially available bead mills, if appropriate with addition of surfactants, as they have already been mentioned above for example in the case of the other formulation types.

Emulsions, for example oil-in-water emulsions (EW), can be prepared for example by means of stirrers, colloid mills and/or static mixtures using aqueous organic solvents and, if appropriate, surfactants as they have already been mentioned above for example in the case of the other formulation types.

Granules can be prepared either by spraying the compounds of formula (I) onto adsorptive, granulated inert material or by applying active substance concentrates onto the surface of carriers such as sand, kaolinites or of granulated inert material, by means of binders, for example polyvinyl alcohol, sodium polyacrylate or alternatively mineral oils. Suitable active substances can also be granulated in the manner which is conventional for the production of fertilizer granules, if desired in a mixture with fertilizers.

Water-dispersible granules are prepared, as a rule, by the customary processes such as spray-drying, fluidized-bed granulation, disk granulation, mixing in high-speed mixers and extrusion without solid inert material. To prepare disk, fluidized-bed, extruder and spray granules, see, for example, processes in “Spray-Drying Handbook” 3rd ed. 1979, G. Goodwin Ltd., London; J. E. Browning, “Agglomeration”, Chemical and Engineering 1967, pages 147 et seq.; “Perry's Chemical Engineer's Handbook”, 5th Ed., McGraw-Hill, New York 1973, p. 8-57. For further details on the formulation of crop protection products, see, for example, G. C. Klingman, “Weed Control as a Science”, John Wiley and Sons, Inc., New York, 1961, pages 81-96 and J. D. Freyer, S. A. Evans, “weed Control Handbook”, 5th Ed., Blackwell Scientific Publications, Oxford, 1968, pages 101-103.

As a rule, the agrochemical preparations comprise 0.1 to 99% by weight, in particular 0.1 to 95% by weight, of compounds of formula (I).

The concentration of compounds of formula (I) in wettable powders is, for example, approximately 10 to 90% by weight, the remainder to 100% by weight being composed of customary formulation components. In the case of emulsifiable concentrates, the concentration of compounds of formula (I) can amount to approximately 1 to 90, preferably 5 to 80, % by weight. Formulations in the form of dusts usually comprise 1 to 30% by weight of compounds of formula (I), preferably in most cases 5 to 20% by weight of compounds of formula (I), while sprayable solutions comprise approximately 0.05 to 80, preferably 2 to 50, % by weight of compounds of formula (I). In the case of water-dispersible granules, the content of compounds of formula (I) depends partly on whether the compounds of formula (I) is in liquid or solid form and on which granulation auxiliaries, fillers and the like are being used. The water-dispersible granules, for example, comprise between 1 and 95% by weight of compounds of formula (I), preferably between 10 and 80% by weight.

In addition, the formulations of compounds of formula (I) mentioned comprise, if appropriate, the adhesives, wetters, dispersants, emulsifiers, penetrants, preservatives, antifreeze agents, solvents, fillers, carriers, colorants, antifoams, evaporation inhibitors, pH regulators and viscosity regulators which are conventional in each case.

Active substances which can be employed as components in mixed formulations or in a tank mix, together with the compounds of formula (I), are, for example, known active substances as they are described in, for example, Weed Research 26, 441-445 (1986), or “The Pesticide Manual”, 10th edition, The British Crop Protection Council and the Royal Soc. of Chemistry, 1994 and the literature cited therein. Herbicides which are known from the literature and which may be combined with the compounds of formula (I) are, for example, the following active substances (note: the compounds are either designated by the “common name” of the International Organization for Standardization (ISO) or by the chemical name, if appropriate together with a customary code number):

acetochlor; acifluorfen; aclonifen; AKH 7088, i.e. [[[1-[5-[2-chloro-4-(trifluoromethyl)phenoxy]-2-nitrophenyl]-2-methoxyethylidene]amino]oxy]acetic acid and its methyl ester; alachlor; alloxydim; ametryn; amidosulfuron; amitrol; AMS, i.e. ammonium sulfamate; anilofos; asulam; atrazine; azimsulfurone (DPX-A8947); aziprotryn; barban; BAS 516H, i.e. 5-fluoro-2-phenyl-4H-3,1-benzoxazin-4-one; benazolin; benfluralin; benfuresate; bensulfuron-methyl; bensulide; bentazone; benzofenap; benzofluor; benzoylprop-ethyl; benzthiazuron; bialaphos; bifenox; bromacil; bromobutide; bromofenoxim; bromoxynil; bromuron; buminafos; busoxinone; butachlor; butamifos; butenachlor; buthidazole; butralin; butylate; cafenstrole (CH-900); carbetamide; cafentrazone (ICI-A0051); CDAA, i.e. 2-chloro-N,N-di-2-propenylacetamide; CDEC, i.e. 2-chloroallyl diethyldithiocarbamate; chlomethoxyfen; chloramben; chlorazifop-butyl, chlormesulon (ICI-A0051); chlorbromuron; chlorbufam; chlorfenac; chlorflurecol-methyl; chloridazon; chlorimuron ethyl; chlornitrofen; chlorotoluron; chloroxuron; chlorpropham; chlorsulfuron; chlorthal-dimethyl; chlorthiamid; cinmethylin; cinosulfuron; clethodim; clodinafop and its ester derivatives (for example clodinafop-propargyl); clomazone; clomeprop; cloproxydim; clopyralid; cumyluron (JC 940); cyanazine; cycloate; cyclosulfamuron (AC 104); cycloxydim; cycluron; cyhalofop and its ester derivatives (for example butyl ester, DEH-112); cyperquat; cyprazine; cyprazole; daimuron; 2,4-DB; dalapon; desmedipham; desmetryn; di-allate; dicamba; dichlobenil; dichlorprop; diclofop and its esters such as diclofop-methyl; diethatyl; difenoxuron; difenzoquat; diflufenican; dimefuron; dimethachlor; dimethametryn; dimethenamid (SAN-582H); dimethazone, clomazon; dimethipin; dimetrasulfuron, dinitramine; dinoseb; dinoterb; diphenamid; dipropetryn; diquat; dithiopyr; diuron; DNOC; eglinazine-ethyl; EL 77, i.e. 5-cyano-1-(1,1-dimethylethyl)-N-methyl-1H-pyrazole-4—carboxamide; endothal; EPTC; esprocarb; ethalfluralin; ethametsulfuron-methyl; ethidimuron; ethiozin; ethofumesate; F5231, i.e. N-[2-chloro-4-fluoro-5-[4-(3-fluoropropyl)-4,5-dihydro-5-oxo-1H-tetrazol-1-yl]-phenyl]ethanesulfonamide; ethoxyfen and its esters (for example ethyl ester, HN-252); etobenzanid (HW 52); fenoprop; fenoxan, fenoxaprop and fenoxaprop-P and their esters, for example fenoxaprop-P-ethyl and fenoxaprop-ethyl; fenoxydim; fenuron; flamprop-methyl; flazasulfuron; fluazifop and fluazifop-P and their esters, for example fluazifop-butyl and fluazifop-P-butyl; fluchloralin; flumetsulam; flumeturon; flumiclorac and its esters (for example pentyl ester, S-23031); flumioxazin (S-482); flumipropyn; flupoxam (KNW-739); fluorodifen; fluoroglycofen-ethyl; flupropacil (UBIC-4243); fluridone; flurochloridone; fluroxypyr; flurtamone; fomesafen; foramsulfuron, fosamine; furyloxyfen; glufosinate; glyphosate; halosafen; halosulfuron and its esters (for example methyl ester, NC-319); haloxyfop and its esters; haloxyfop-P (=R-haloxyfop) and its esters; hexazinone; imazamethabenz-methyl; imazapyr; imazaquin and salts such as the ammonium salt; imazethamethapyr; imazethapyr; imazosulfuron; iodosulfuron-methyl and its salts such as the sodium salt, ioxynil; isocarbamid; isopropalin; isoproturon; isouron; isoxaben; isoxaflutole, isoxapyrifop; karbutilate; lactofen; lenacil; linuron; MCPA; MCPB; mecoprop; mefenacet; mefluidid; mesosulfuron, mesotrione, metamitron; metazachlor; methabenzthiazuron; metham; methazole; methoxyphenone; methyldymron; metabenzuron, methobenzuron; metobromuron; metolachlor; metosulam (XRD 511); metoxuron; metribuzin; metsulfuron-methyl; MH; molinate; monalide; monocarbamide dihydrogensulfate; monolinuron; monuron; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorobenzoyl)-1-methyl-5-benzyloxypyrazol; neburon; nicosulfuron; nipyraclophen; nitralin; nitrofen; nitrofluorfen; norflurazon; orbencarb; oryzalin; oxadiargyl (RP-020630); oxadiazon; oxyfluorfen; paraquat; pebulate; pendimethalin; perfluidone; phenisopham; phenmedipham; picloram; piperophos; piributicarb; pirifenop-butyl; pretilachlor; primisulfuron-methyl; procyazine; prodiamine; profluralin; proglinazine-ethyl; prometon; prometryn; propachlor; propanil; propaquizafop and its esters; propazine; propham; propisochlor; propyzamide; prosulfalin; prosulfocarb; prosulfuron (CGA-152005); prynachlor; pyrazolinate; pyrazon; pyrazosulfuron-ethyl; pyrazoxyfen; pyridate; pyrithiobac (KIH-2031); pyroxofop and its esters (for example propargyl ester); quinclorac; quinmerac; quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole; secbumeton; sethoxydim; siduron; simazine; simetryn; SN 106279, i.e. 2-[[7-[2-chloro-4-(trifluoromethyl)phenoxy]-2-naphthalenyl]oxy]propanoic acid and its methyl ester; sulcotrione, sulfentrazon (FMC-97285, F-6285); sulfazuron; sulfometuron-methyl; sulfosate (ICI-A0224); TCA; tebutam (GCP-5544); tebuthiuron; terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazol-1-carboxamide; thenylchlor (NSK-850); thiazafluron; thizopyr (Mon-13200); thidiazimin (SN-24085); thifensulfuron-methyl; thiobencarb; tiocarbazil; tralkoxydim; tri-allate; triasulfuron; triazofenamide; tribenuron-methyl; triclopyr; tridiphane; trietazine; trifluralin; triflusulfuron and esters (for example methyl ester, DPX-66037); trimeturon; tsitodef; vernolate; WL 110547, i.e. 5-phenoxy-1-[3-(trifluoromethyl)phenyl]-1H-tetrazole; UBH-509; D-489; LS 82-556; KPP-300; NC-324; NC-330; KH-218; DPX-N8189; SC-0774; DOWCO-535; DK-8910; V-53482; PP-600; MBH-001; K1H-9201; ET-751; K1H-6127 and K1H-2023.

For use, the formulations which are present in commercially available form are, if appropriate, diluted in the customary manner, for example using water in the case of wettable powders, emulsifiable concentrates, dispersions and water-dispersible granules. Preparations in the form of dusts, soil granules, granules for broadcasting and sprayable solutions are conventionally not diluted further with other inert substances prior to use.

The application rate required of the compounds of formula (I) varies with the external conditions such as, inter alia, temperature, humidity and the nature of the herbicide used. It may vary within wide limits, for example between 0.001 and 10.0 kg/ha or more of active substance, but it is preferably between 0.005 and 5 kg/ha, and more preferably between 0.05 and 1 kg/ha.

### B. FORMULATION EXAMPLES

a) A dust is obtained by mixing 10 parts by weight of a compound of formula (I) and 90 parts by weight of talc as inert material and grinding the mixture in a hammer mill.

b) A wettable powder which is readily dispersible in water is obtained by mixing 25 parts by weight of a compound of formula (I), 64 parts by weight of kaolin-containing quartz as inert material, 10 parts by weight of potassium lignosulfonate and 1 part by weight of sodium oleoylmethyltaurinate as wetter and dispersant and grinding the mixture in a pinned-disk mill.

c) A dispersion concentrate which is readily dispersible in water is obtained by mixing 20 parts by weight of a compound of formula (I) with 6 parts by weight of alkylphenol polyglycol ether (®Triton X 207), 3 parts by weight of isotridecanol polyglycol ether (8 EO) and 71 parts by weight of paraffinic mineral oil (boiling range for example approx. 255 to above 277° C.) and grinding the mixture in a ball mill to a fineness of below 5 microns.

d) An emulsifiable concentrate is obtained from 15 parts by weight of a compound of formula (I), 75 parts by weight of cyclohexanone as solvent and 10 parts by weight of oxethylated nonylphenol as emulsifier.

e) Water-dispersible granules are obtained by mixing

75 parts by weight of a compound of formula (I),

10 parts by weight of calcium ligno-sulfonate,

5 parts by weight of sodium laurylsulfate,

3 parts by weight of polyvinyl alcohol and

7 parts by weight of kaolin,

grinding the mixture in a pinned disk mill and granulating the powder in a fluidized bed by spraying on water as granulation liquid.

f) Alternatively, water-dispersible granules are obtained by homogenizing and precomminuting, on a colloid mill,

25 parts by weight of a compound of formula (I),

5 parts by weight of sodium 2,2′-dinaphthylmethane-6,6′-disulfonate,

2 parts by weight of sodium oleoylmethyltaurinate,

1 part by weight of polyvinyl alcohol,

17 parts by weight of calcium carbonate and

50 parts by weight of water,

subsequently grinding the mixture on a bead mill and atomizing and drying the resulting suspension in a spray tower by means of a single-substance nozzle.

### C. BIOLOGICAL EXAMPLES

Pre-Emergence Effect on Weeds

Seed of various broad-leaf and grass weed species were sown and compound of formula (I), dissolved in a mixture of acetone and water, was applied at a rate of 500 g/ha or less to the soil surface. The weed species used were Amaranthus retroflexus, Abutilon theophrasti, Alopecurus myosuroides, Avena fatua, Brassica rapa and Echinochloa crus-galli.

Post-Emergence Effect on Weeds

Seed of the weed species Amaranthus retroflexus, Abutilon theophrasti, Alopecurus myosuroides, Avena fatua, Brassica rapa and Echinochloa crus-galli were sown in soil and grown up to a 1-3 leaves stage. A post-emergence application of compound of formula (I), dissolved in a mixture of acetone and water, was applied at a rate of 500 g/ha or less.

Two weeks after treatment in the above test methods, weed control was assessed as a percentage reduction in plant growth, in comparison with untreated control.

The following compound numbers gave, at 500 g/ha or less, a very good herbicidal activity of one or more of the above weed species in the above test methods: 1, 3 to 21,23 to 25, 27 to 33, 35 to 40, 42,44,46 to 65,68 to 71, 76 to 82, 84 to 86 and 88 to 90.

Tolerance by Crop Plants

In further greenhouse experiments, seeds of a number of crop plants (wheat, maize and soya) were placed in sandy loam soil and covered with soil. Some of the pots were treated immediately as described in the above pre-emergence test method, and the remaining pots were placed in a greenhouse and six days later were sprayed with various doses of compounds of formula (I), as described in the above post-emergence test method. Visual scoring two weeks after treatment showed that some of the compounds of the invention showed little or no damage to the above crop species when applied pre- and post-emergence. Some of the compounds of the formula (I) have a high selectivity and are therefore suitable for controlling undesired plant growth in agricultural crops.

1. A method for the control of weeds at a locus, which comprises applying thereto a herbicidally effective amount of at least one compound which is a 3,5-dicyanophenoxy derivative of formula (I): 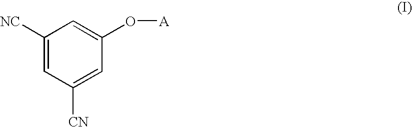
wherein
A is a formula A1 to A5: 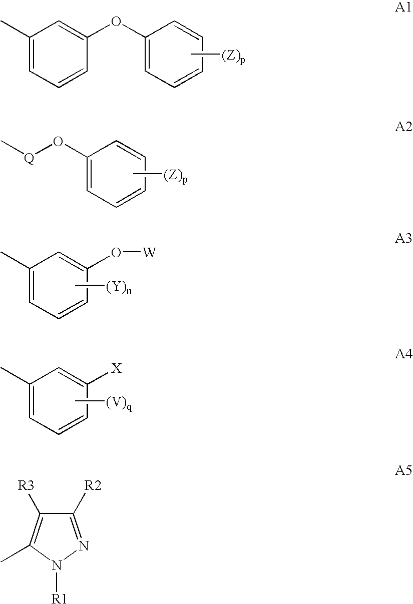
Q is a formula Q1 to Q12: 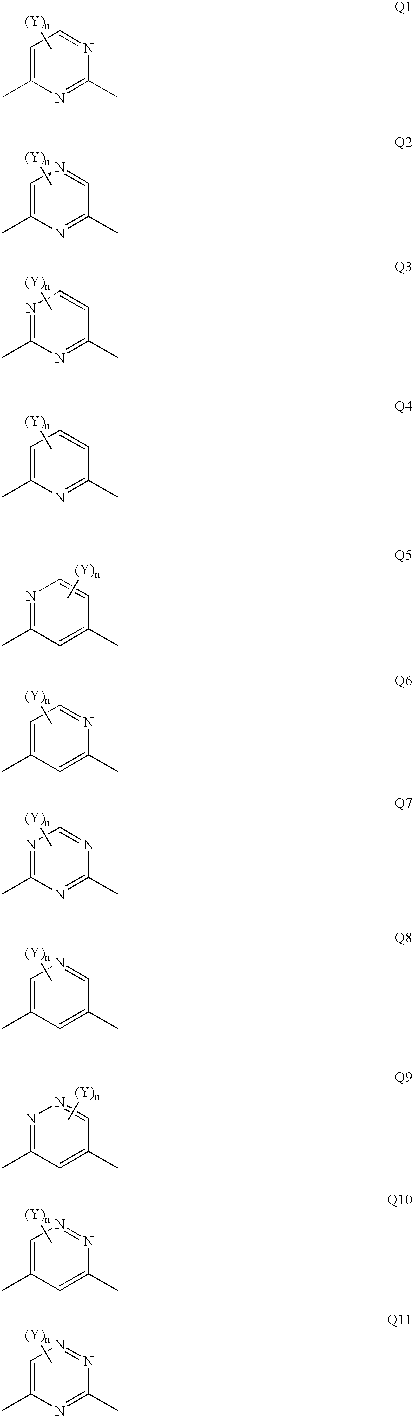 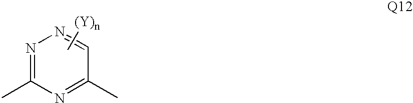
wherein the linking bond shown on the lefthand side of each formula is attached to the 3,5-dicyanophenoxy moiety of formula (I);
W is a formula W1 to W6: 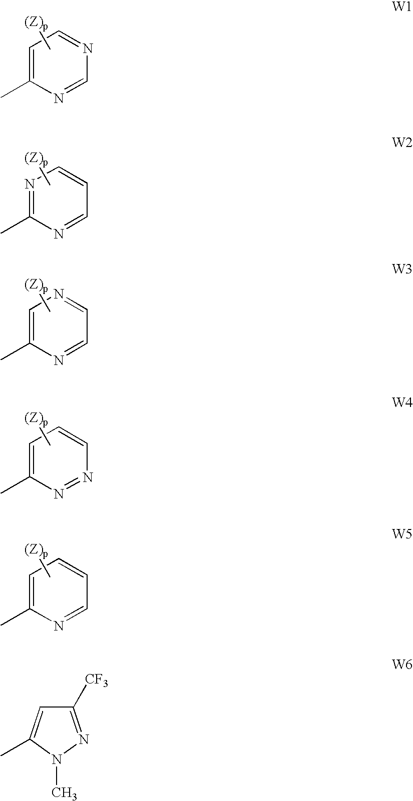
X is halogen, (C₁-C₈)alkyl, (C₁-C₈)haloalkyl, (C₂-C₆)alkenyl, (C₂-C₆)haloalkenyl, (C₂-C₆)alkynyl, (C₂-C₆)haloalkynyl, NO₂, CN, OH, OSO₂R⁴, (C₁-C₆)alkoxy, (C₁-C₆)haloalkoxy, (C₂-C₆)alkenyloxy, (C₂-C₆)haloalkenyloxy, —OC(R⁵R⁶)CO₂R⁴, OC(O)R⁷, —OCH(R )CO₂R⁴ C(R⁵R⁶)OR⁸ or N R⁵R⁶,
each Y is the same or different halogen;
each Z is independently selected from NO₂, CN, CO₂R², halogen, (C₁-C₈)alkyl, (C₁-C₈)haloalkyl, (C₁-C₆)alkoxy, (C₁-C₆)haloalkoxy, —S(O)ₘ(CH₂)ᵣR⁸, —S(O)ₘR⁴, —CH₂S(O)ₘR⁸, R⁸, NR⁵R⁶, CONR⁵R⁶, CHO and 1-pyrrolyl; V is Z with the exclusion of CO₂R²;
R¹ is (C₁-C₈)alkyl, (C₁-C₈)haloalkyl or —(CH₂)ₛR⁸;
R² is hydrogen, (C₁-C₈)alkyl or (C₁-C₈)haloalkyl;
R³ is hydrogen, halogen, (C₁-C₈)alkyl or (C₁-C₈)haloalkyl;
R⁴ is (C₁-C₈)alkyl or (C₁-C₈)haloalkyl;
R⁵ and R⁶ are each independently hydrogen or (C₁-C₈)alkyl;
R⁷ is (C₁-C₈)alkyl, cycloalkyl, R⁸ or thienyl;
R⁸ is phenyl unsubstituted or substituted by one or more radicals selected from the group consisting of halogen, (C₁-C₈)alkyl, (C₁-C₈)haloalkyl, (C₂-C₆)alkenyl, (C₂-C₆)alkynyl, NO₂, CN, —S(O)ₘR⁴, (C₁-C₆)alkoxy, (C₁-C₆)haloalkoxy and CO₂R⁴;
m is zero, one or two;
n, r and s are each independently zero or one;
p is zero or an integer from one to five;
q is zero or an integer from one to four;
and an agriculturally acceptable salt thereof.

2. A method according to claim 1 wherein the locus is an area used, or to be used, wherein the compound of formula (I) is used for the control of undesired plants in crops of useful plants.

3. The method according to claim 2, wherein the useful plants are transgenic useful plants.

4. A method according to claim 1 in which:
A is a formula A1, wherein Z is NO₂, CN, CO₂R² in which R² is (C₁-C₄)alkyl, or is halogen, (C₁-C₄)haloalkyl, (C₁-C₄)haloalkoxy, —SO₂CH₂R⁸ in which R⁸ is phenyl substituted by one or more halogen radicals, or is —CH₂SR⁸ in which R⁸ is phenyl, or is CONH₂, CHO or 1-pyrrolyl; and
p is zero or an integer from one to five.

5. A method according to claim 1 in which:
A is a formula A2, wherein Q is a formula Q1, Q2 or Q3 in which Z is CN or halogen;
n is zero and p is zero, 1 or 2.

6. A method according to claim 1 in which:
A is a formula A3, wherein W is a formula W1, W2, W3, W4 or W5; Z is halogen, NH₂, (C₁-C₄)alkyl, (C₁-C₄)haloalkyl, (C₁-C₄)alkoxy, —S(O)ₘR⁴ in which R⁴ is (C₁-C₄)alkyl, or is R⁸ in which R⁸ is phenyl;
n is zero and p is zero, 1, 2 or 3.

7. A method according to claim 1 in which:
A is a formula A4, wherein X is halogen, (C₁-C₄)alkyl, (C₁-C₄)haloalkyl, (C₂-C₄)haloalkenyl, (C₂-C₄)alkynyl, CN, NO₂, OH, OSO₂R⁴ in which R⁴ is (C₁-C₄)haloalkyl, or is (C₁-C₄)alkoxy, (C₁-C₄)haloalkoxy, (C₂-C₄)haloalkenyloxy, —OC(R⁵R⁶)CO₂R⁴ in which R⁴ is (C₁-C₄)alkyl and R⁵ and R⁶ are each independently hydrogen or (C₁-C₄)alkyl, or is OC(O)R⁷ in which R⁷ is (C₁-C₄)alkyl, (C₃-C₆)cycloalkyl or thienyl, or R⁷ is R⁸ in which R⁸ is phenyl unsubstituted or substituted by one or more radicals selected from the group consisting of halogen, (C₁-C₄)haloalkyl, NO₂, (C₁-C₄)alkoxy and (C₁-C₄)haloalkoxy, or is —OCH(R⁸)CO₂R⁴ in which R⁴ is (C₁-C₄)alkyl and R⁸ is phenyl, or is —C(R⁵R⁶)OR⁸ in which R⁵ and R⁶ are each independently hydrogen or (C₁-C₄)alkyl, and R⁸ is phenyl unsubstituted or substituted by one or two CN groups, or is NR⁵R⁶ in which R⁵ and R⁶ are each independently hydrogen or (C₁-C₄)alkyl;
V is CN, halogen, (C₁-C₄)alkoxy or CONH₂; and q is zero or 1.

8. A method according to claim 1 in which:
A is a formula A5, wherein R¹ is (C₁-C₄)alkyl, R² is (C₁-C₄)haloalkyl and R³ is H.

9. A compound of formula (I) as defined in claim 1 with the provisos:
i) that when A is a formula A1, then Zₚ is not 3,5-dicyano;
ii) that when A is a formula A4 and X is chloro, then V is not 4-chloro;
iii) that when A is a formula A4 and X is methyl, then q is not zero; and
iv) that when A is a formula A4 and X is methyl, then V is not 2-methyl; 2,5-dimethyl or 2,6-dimethyl; or an agriculturally acceptable salt thereof.

10. A herbicidal composition comprising an effective amount of a compound of formula (I) as defined in claim 1 or an agriculturally acceptable salt thereof, in association with an agriculturally acceptable diluent or carrier and/or surface active agent.

11. The use of compounds of formula (I) as defined in claim 1 or of herbicidal compositions as defined in claim 10 as a herbicide or plant growth regulator.

12. A process for the preparation of a compound of formula (I) as defined in claim 9, which process comprises:
a) where A is a formula Al and Z and p are as defined in claim 9, reacting a compound of formula (II): 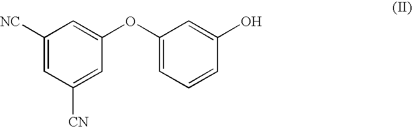
with a compound of formula (III): 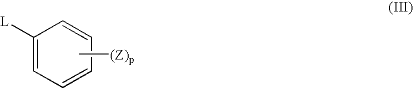
wherein L is a leaving group, and Z and p are as defined in claim 9;
b) where A is a formula A3 and W, Y and n are as defined in claim 9, reacting a compound of general formula (IV): 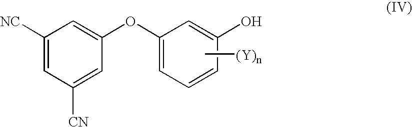
wherein Y and n are as defined in claim 9, with a compound of formula (V):
L-W (V)
wherein L is a leaving group, and W is as defined in claim 9;
c) where A is a formula A2 and Q, Z and p are as defined in claim 9, reacting a compound of formula (VI): 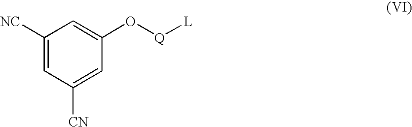
wherein Q is as defined in claim 9 and L is a leaving group, with a phenol of formula (VI ): 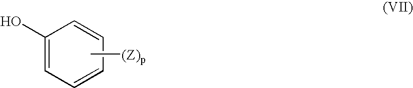
wherein Z and p are as defined in claim 9;
d) where A is a formula A4 and X, V and q are as defined in claim 9, reacting a compound of formula (VIII): 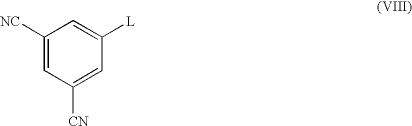
wherein L is a leaving group, with a compound of formula (IX): 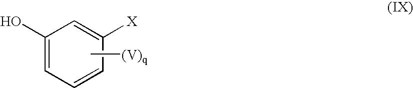
wherein X, V and q are as defined in claim 9;
e) where A is a formula A⁵ and R¹, R² and R³ are as defined in claim 9, reacting a compound of formula (VIII) above, with a compound of formula (X): 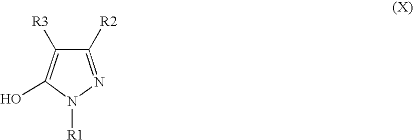
wherein R¹, R² and R³ are as defined in claim 9;
f) where A is a formula Al and Z and p are as defined in claim 9, reacting a compound of general formula (XI): 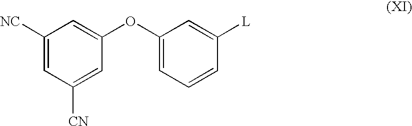
wherein L is a leaving group, with a phenol of formula (VII) as defined above, in the presence of a catalyst;
g) where A is a formula A4, V and q are as defined in claim 9 and X is OC(O)R⁷ wherein R⁷ is as defined in claim 9, reacting a compound of formula (XII): 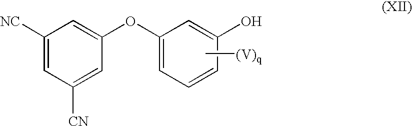
wherein V and q are as defined in claim 9, with a compound of formula (XIII):
R⁷C(O)Cl (XIII)
wherein R⁷ is as defined in claim 9;
h) where the compound of formula (I) is a formula (II) or (XII) as defined above, reacting a compound of formula (VIII) as defined above, with a compound of formula (IX) above wherein X is OH, and q is zero, or V and q are as defined above;
i) where the compound of formula (I) corresponds to a formula (IV) as defined above, reacting a compound of formula (VIII) as defined above, with a compound of formula (XIV): 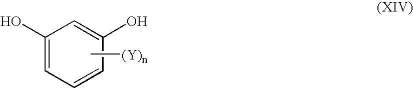
wherein Y and n are as defined in claim 9;
k) where the compound of formula (I) corresponds to a compound of formula (XI) as defined above wherein L is halogen, reacting a compound of formula (VIII) as defined above, with a compound of formula (IX) wherein X is halogen and q is zero; and
l) if desired, converting a resulting compound of formula (I) into an agriculturally acceptable salt thereof.

13. A compound of formula (VI): 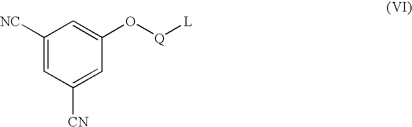
wherein Q is defined in claim 1 and L is a halogen or alkylsulphonyl.
